(19) United States
(12) Patent Application Publication
(10) Pub. No.: US 2026/0332306 A1
(43) Pub. Date: Oct. 22, 2026

(54) UE INDICATION OF PUSCH REPETITION SUPPORT

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Little Elm, TX (US)

(21) Appl. No.: 19/578,665

(22) Filed: Mar. 25, 2026

Related U.S. Application Data
(60) Provisional application No. 63/792,442, filed on Apr. 22, 2025.
(60) Provisional application No. 63/820,991, filed on Jun. 10, 2025.
(60) Provisional application No. 63/850,090, filed on Jul. 24, 2025.

(51) Int. Cl. H04L 1/08

(52) U.S. Cl. CPC H04L 1/08

(57) ABSTRACT

A method of operating a user equipment (UE) includes generating a medium access control (MAC) protocol data unit (PDU). The MAC PDU includes a common control channel (CCCH) message, and information indicating that the UE supports message 5 (Msg5) physical uplink shared channel (PUSCH) repetition. The message also includes transmitting the MAC PDU.

### CROSS-REFERENCE TO RELATED APPLICATION(S) AND CLAIM OF PRIORITY

This application claims priority under 35 U.S.C. § 119(e) to U.S. Provisional Patent Application No. 63/792,442 filed on Apr. 22, 2025, U.S. Provisional Patent Application No. 63/820,991 filed on Jun. 10, 2025, and U.S. Provisional Patent Application No. 63/850,090 filed on Jul. 24, 2025. The above-identified provisional patent applications are hereby incorporated by reference in their entirety.

### TECHNICAL FIELD

This disclosure relates generally to wireless networks. More specifically, this disclosure relates to user equipment (UE) indication of physical uplink shared channel (PUSCH) repetition support.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for UE indication of PUSCH repetition support.

In one embodiment, a method of operating a user equipment (UE) is provided. The method includes generating a medium access control (MAC) protocol data unit (PDU). The MAC PDU includes a common control channel (CCCH) message, and information indicating that the UE supports message 5 (Msg5) physical uplink shared channel (PUSCH) repetition. The message also includes transmitting the MAC PDU.

In another embodiment, a method of operating a base station (BS) is provided. The method includes receiving a MAC PDU generated by a UE. The MAC PDU includes a CCCH message, and information indicating that the UE supports Msg5 PUSCH repetition.

In yet another embodiment, an electronic device is provided. The electronic device includes at least on processor including processing circuitry, and memory storing instruction. The instructions, when executed by the at least one processor individually or collectively, cause the electronic device to generate a MAC PDU. The MAC PDU includes a CCCH message, and information indicating the electronic device supports Msg5 PUSCH repetition. The instructions, when executed by the at least one processor individually or collectively, also cause the electronic device to transmit the MAC PDU.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIGS. 4A and 4B illustrate an example UE procedure for indicating to a gNB a UE capability of supporting Msg5 PUSCH repetition scheduled by DCI format 0_0 with CRC scrambled by C-RNTI according to embodiments of the present disclosure;

FIG. 5 illustrates an example MAC CE according to embodiments of the present disclosure;

FIG. 6 illustrates an example MAC CE payload according to embodiments of the present disclosure;

FIG. 7 illustrates an example MAC PDU capability header according to embodiments of the present disclosure;

FIG. 8 illustrates an example procedure for UE triggered beam reporting according to embodiments of the present disclosure;

FIG. 9 illustrates another example procedure for UE triggered beam reporting according to embodiments of the present disclosure;

FIG. 10 illustrates another example procedure for UE triggered beam reporting according to embodiments of the present disclosure;

FIG. 11 illustrates another example procedure for UE triggered beam reporting according to embodiments of the present disclosure;

FIG. 12 illustrates an example method for UE indication of PUSCH repetition support according to embodiments of the present disclosure; and

FIG. 13 illustrates another example method for UE indication of PUSCH repetition support according to embodiments of the present disclosure.

### DETAILED DESCRIPTION

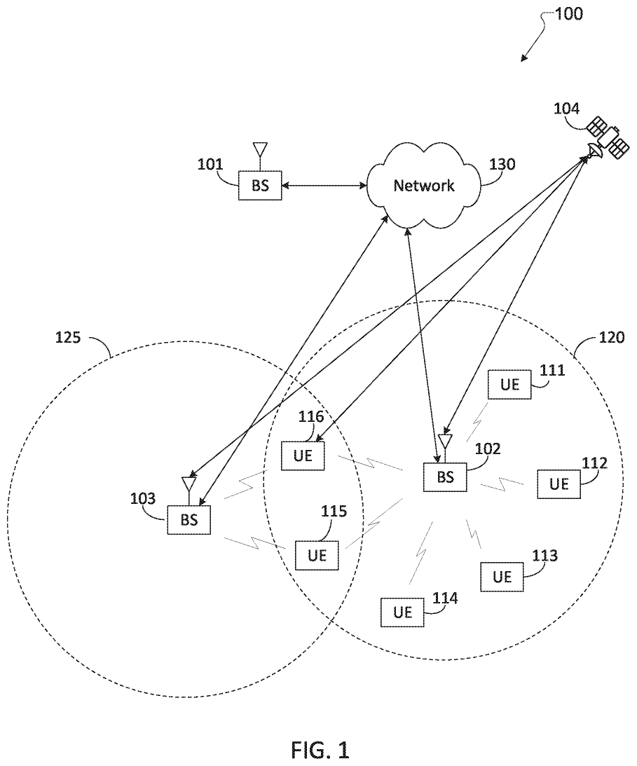

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for UE indication of PUSCH repetition support. In certain embodiments, one or more of the gNBs 101-103 includes circuitry, programing, or a combination thereof, to support UE indication of PUSCH repetition support in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

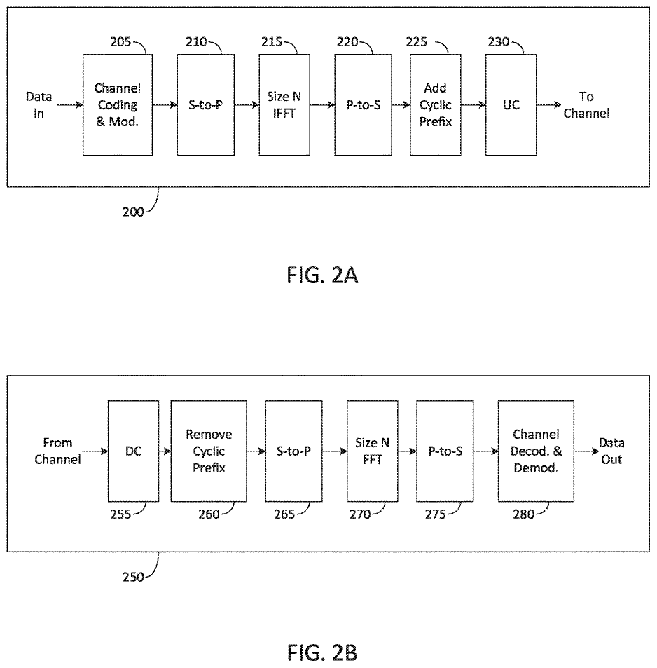

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support UE indication of PUSCH repetition support as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

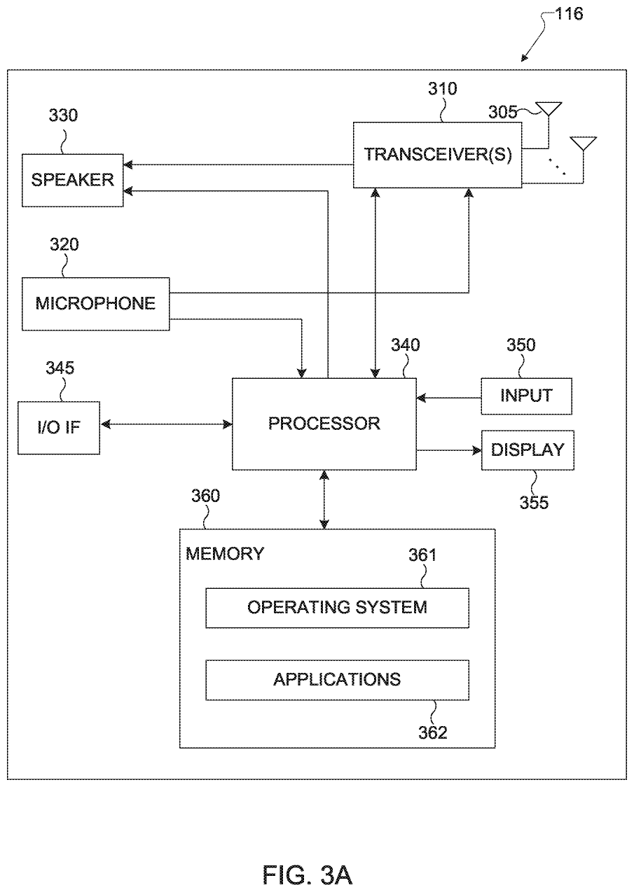

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for UE indication of PUSCH repetition support as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support UE indication of PUSCH repetition support as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

In the next generation wireless communication system (e.g., 5G, beyond 5G, 6G) operating in higher frequency (mmWave, terahertz) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window, and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below: (y*(number of slots in a radio frame)+x-Monitoring-offset-PDCCH-slot) mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the medium access control (MAC) entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), random access (RA) is supported. Random access (RA) is used to achieve uplink (UL) time synchronization. RA is used during In the next generation wireless communication system (e.g., 5G, beyond 5G, 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in an RRC_CONNECTED state. Several types of random-access procedure are supported such as contention based random access, contention free random access and each of these can be one of 2 step or 4 step random access.

In contention based random access (CBRA), also referred as 4 step CBRA, the UE first transmits a Random Access preamble (also referred to as Msg1) and then waits for a Random access response (RAR) in the RAR window. The RAR is also referred to as Msg2. A next generation node B (gNB) transmits the RAR on the physical downlink shared channel (PDSCH). A PDCCH scheduling the PDSCH carrying the RAR is addressed to a RA-radio network temporary identifier (RA-RNTI). The RA-RNTI identifies the time-frequency resource (also referred to as a physical RA channel [PRACH] occasion or PRACH transmission [TX] occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted the Msg1, (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for a normal UL [NUL] carrier and 1 for a supplementary UL [SUL] carrier. Several RARs for various Random-access preambles detected by the gNB can be multiplexed in the same RAR media access control (MAC) protocol data unit (PDU) by the gNB. A RAR in MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in a RACH configuration) number of times, the UE goes back to the first step (i.e., select a random access resource [preamble/RACH occasion]) and transmits the RA preamble. A backoff may be applied before going back to first step.

If the RAR corresponding to its RA preamble transmission is received, the UE transmits a message 3 (Msg3) in the UL grant received in the RAR. The Msg3 includes a message such as an RRC connection request, RRC connection re-establishment request, RRC handover confirm, scheduling request, SI request etc. It may include the UE identity (i.e., cell-radio network temporary identifier [C-RNTI] or system architecture evolution [SAE]-temporary mobile subscriber identity [S-TMSI] or a random number). After transmitting the Msg3, the UE starts a contention resolution timer. While the contention resolution timer is running, if UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (first X bits of common control channel [CCCH] service data unit [SDU] transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step (i.e., select random access resource [preamble/RACH occasion]) and transmits the RA preamble. A backoff may be applied before going back to first step.

Contention free random access (CFRA), also referred to as legacy CFRA or 4 step CFRA, is used for scenarios such as handover where low latency is required, timing advance establishment for secondary cell (Scell), etc. An evolved node B (eNB) assigns to the UE a dedicated Random access preamble. The UE transmits the dedicated RA preamble. The eNB transmits the RAR on a PDSCH addressed to a RA-RNTI. The RAR conveys an RA preamble identifier and timing alignment information. The RAR may also include an UL grant. The RAR is transmitted in RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

For certain events such has handover and beam failure recovery if dedicated preamble(s) are assigned to UE, during first step of random access (i.e., during random access resource selection for Msg1 transmission) the UE determines whether to transmit a dedicated preamble or non-dedicated preamble. Dedicated preambles are typically provided for a subset of SSBs/CSI RSs. If there are no SSB/CSI RS having a DL RSRP above a threshold amongst the SSBs/CSI RSs for which contention free random access resources (i.e., dedicated preambles/ROs) are provided by the gNB, the UE selects a non-dedicated preamble. Otherwise, the UE selects a dedicated preamble. During the RA procedure, one random access attempt can be CFRA while other random access attempts can be CBRA.

For 2 step contention based random access (2 step CBRA), in the first step, the UE transmits a random access preamble on a PRACH and a payload (i.e., MAC PDU) on a PUSCH. The random access preamble and payload transmission is also referred to as a message A (MsgA). In the second step, after the MsgA transmission, the UE monitors for a response from the network (i.e., a gNB) within a configured window. The response is also referred to as a message B (MsgB). A gNB transmits the MsgB on a PDSCH. A PDCCH scheduling the PDSCH carrying the MsgB is addressed to a MsgB-radio network temporary identifier (MSGB-RNTI). The MSGB-RNTI identifies the time-frequency resource (also referred to as a PRACH occasion or PRACH TX occasion or RACH occasion) in which the RA preamble was detected by the gNB. The MSGB-RNTI is calculated as follows: RA-RNTI=1+s_id+14*t_id+14*80*f_id+14*80*8*ul_carrier_id+14× 80×8×2, where s_id is the index of the first OFDM symbol of the PRACH occasion where UE has transmitted the MsgA (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier).

If a CCCH SDU was transmitted in the MsgA payload, the UE performs contention resolution using the contention resolution information in the MsgB. The contention resolution is successful if the contention resolution identity received in the MsgB matches the first 48 bits of the CCCH SDU transmitted in the MsgA. If a C-RNTI was transmitted in the MsgA payload, the contention resolution is successful if the UE receives a PDCCH addressed to the C-RNTI. If contention resolution is successful, the random access procedure is considered successfully completed. Instead of contention resolution information corresponding to the transmitted MsgA, the MsgB may include fallback information corresponding to the random access preamble transmitted in the MsgA. If the fallback information is received, the UE transmits a Msg3 and performs contention resolution using a Msg4 as in CBRA procedure. If the contention resolution is successful, the random access procedure is considered successfully completed. If the contention resolution fails upon fallback (i.e., upon transmitting the Msg3), the UE retransmits the MsgA. If the configured window in which the UE monitors for a network response after transmitting the MsgA expires and the UE has not received a MsgB including contention resolution information or fallback information as explained above, the UE retransmits MsgA. If the random access procedure is not successfully completed even after transmitting the MsgA configurable number of times, the UE falls back to the 4 step RACH procedure (i.e., the UE only transmits the PRACH preamble).

A MsgA payload may include one or more of a CCCH SDU, dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include a UE ID (e.g., a random ID, S-TMSI, C-RNTI, resume ID, etc.) along with a preamble in the first step. The UE ID may be included in the MAC PDU of the MsgA. AUE ID such as a C-RNTI may be carried in the MAC CE, wherein the MAC CE is included in The MAC PDU. Other UE IDs (such as a random ID, S-TMSI, C-RNTI, resume ID, etc.) may be carried in a CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before the UE is attached to the network), then the UE ID is the random ID. When the UE performs an RA in an IDLE state after the UE is attached to network, the UE ID is an S-TMSI. If the UE has an assigned C-RNTI (e.g., in a connected state), the UE ID is the C-RNTI. In case the UE is in an INACTIVE state, the UE ID is a resume ID. In addition to the UE ID, some addition control information can be sent in a MsgA. The control information may be included in the MAC PDU of the MsgA. The control information may include one or more of a connection request indication, connection resume request indication, SI request indication, buffer status indication, beam information (e.g., one or more DL TX beam ID[s] or SSB ID[s]), beam failure recovery indication/information, data indicator, cell/BS/TRP switching indication, connection re-establishment indication, reconfiguration complete or handover complete message, etc.

In the case of 2 step contention free random access (2 step CFRA), the gNB assigns to the UE dedicated random access preamble(s) and PUSCH resource(s) for MsgA transmission. RACH occasions (ROs) to be used for preamble transmission may also be indicated. In the first step, the UE transmits a random access preamble on a PRACH and a payload on a PUSCH using the contention free random access resources (i.e., dedicated preamble/PUSCH resource/RO). In the second step, after the MsgA transmission, the UE monitors for a response from the network (i.e., gNB) within a configured window. The response is also referred to as a MsgB.

A gNB transmits the MsgB on a PDSCH. A PDCCH scheduling the PDSCH carrying the MsgB is addressed to a MsgB-radio network temporary identifier (MSGB-RNTI). The MSGB-RNTI identifies the time-frequency resource (also referred to as a PRACH occasion or PRACH TX occasion or RACH occasion) in which the RA preamble was detected by the gNB. The MSGB-RNTI is calculated as follows: RA-RNTI=1+s_id+14*t_id+14*80*f_id+14*80*8*ul_carrier_id+14× 80×8×2, where s_id is the index of the first OFDM symbol of the PRACH occasion where the UE has transmitted the Msg1 (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for an NUL carrier and 1 for an SUL carrier).

If the UE receives a PDCCH addressed to the C-RNTI, the random access procedure is considered successfully completed. If the UE receives fallback information corresponding to its transmitted preamble, the random access procedure is considered successfully completed.

Beam management is supported in the next generation wireless communication system (e.g., 5G, beyond 5G, 6G). In existing beam management procedures, the network may configure/activate frequent periodic or semi-persistent beam reporting (e.g., N best beams and corresponding L1-RSRPs) or trigger frequent aperiodic beam reporting to timely acquire the best/preferred beam for data/control transmissions. However, this clearly results in large UL reporting overhead and control signaling overhead. At the same time, if less frequent beam reporting is configured, the network could not always acquire the ‘best/preferred’ beam(s), as the beam reporting by the UE may be outdated, thus leading to performance degradation. Given that the UE has better and more-timely knowledge of beam quality changes, a UE-initiated beam reporting procedure can lead to more timely beam reports yet with reduced reporting overhead. Under such a procedure, if the UE determines that, e.g., current beam(s) quality becomes poor, the UE can trigger beam reporting without the network needing to configure or trigger frequent reporting. There are presently two methods (referred to as Mode A and Mode B) for sending the UE initiated beam report.

In the case of Mode A based UE initiated (or event triggered) beam reporting
The UE transmits UCI on PUCCH for a UE initiated (or event triggered) beam report.
The UE receives a UL grant (PUSCH) for the UE initiated (or event triggered) beam report
The UE transmits the UE initiated (or event triggered) beam report in the received UL grant.

In the case of Mode B based UE initiated (or event triggered) beam reporting
The UE is configured with configured grants (CG PUSCH) for the UE initiated (or event triggered) beam report
The UE transmits UCI on a PUCCH notifying the network that the UE is going to transmit a UE initiated beam report in the configured grant
The UE transmits the UE initiated (or event triggered) beam report in the configured grant

An issue with the above Mode A and Mode B based UE initiated (or event triggered) beam reporting is that the UE may not be able to transmit PUCCH/PUSCH if the UE is not UL synchronized. One option is that UE can initiate random access procedure and transmit a UE initiated (or event triggered) beam report in first UL grant after completion of random access procedure or in UL grant scheduled by PDCCH addressed to C-RNTI based on which random access procedure is successfully completed. However, an issue with this approach is that the network does not know whether the UE is going to transmit the UE initiated beam report in this UL grant, as the network does not know whether this random access procedure is initiated for the UE initiated beam report or not. Various embodiments of the present disclosure provide mechanisms for UE PUCCH/PUSCH transmission if the UE is not UL synchronized.

In the next generation wireless communication system (e.g., 5G, beyond 5G, 6G), message 5 (Msg5) physical uplink shared channel (PUSCH) can be a coverage bottleneck during the initial access. This is primarily due to the large payload size of Msg5 (e.g., exceeding 100 Bytes, which is 1 to 2 orders of magnitudes larger than the typical Msg3 payload size). Given that Msg5 PUSCH is scheduled by DCI format 0_0 with CRC scrambled by C-RNTI and does not currently support repetition transmission, enhancements to support PUSCH repetition scheduled by DCI 0_0 with C-RNTI are desirable. Various embodiments of the present disclosure provide mechanisms to support PUSCH repetition scheduled by DCI 0_0 with C-RNTI, as well as to signal the UE's capability to support Msg5 PUSCH repetition scheduled by DCI 0_0 with C-RNTI in msg3.

In some embodiments, up to 12 logical channel identifier (LCID) or extended LCID (eLCID) values (e.g., from an extended LCID space) can be reserved for UE Msg5 PUSCH repetition scheduled by DCI format 0_0 with CRC scrambled by C-RNTI. In embodiments such as these, an (e)LCID is reserved for each of the following:
a CCCH of size 48 bits for a UE supporting Msg5 PUSCH repetition, except for a reduced capability (RedCap) or enhanced RedCap (eRedCap) UE
a CCCH of size 64 bits for a UE supporting Msg5 PUSCH repetition, except for an (e)RedCap UE
a CCCH of size 48 bits for a RedCap UE supporting Msg5 PUSCH repetition
a CCCH of size 64 bits for a RedCap UE supporting Msg5 PUSCH repetition
a CCCH of size 48 bits for an eRedCap UE supporting Msg5 PUSCH repetition
a CCCH of size 64 bits for an eRedCap UE supporting Msg5 PUSCH repetition
a CCCH of size 48 bits for a UE supporting Msg5 PUSCH repetition and PUCCH repetition of a Msg4 hybrid automatic repeat request-acknowledgement (HARQ-ACK), except for an (e)RedCap UE
a CCCH of size 64 bits for a UE supporting Msg5 PUSCH repetition and PUCCH repetition of a Msg4 HARQ-ACK, except for an (e)RedCap UE
a CCCH of size 48 bits for a RedCap UE supporting Msg5 PUSCH repetition and PUCCH repetition of a Msg4 HARQ-ACK
a CCCH of size 64 bits for a RedCap UE supporting Msg5 PUSCH repetition and PUCCH repetition of a Msg4 HARQ-ACK
a CCCH of size 48 bits for an eRedCap UE supporting Msg5 PUSCH repetition and PUCCH repetition of a Msg4 HARQ-ACK
a CCCH of size 64 bits for an eRedCap UE supporting SBFD (or full duplexing) and PUCCH repetition of a Msg4 HARQ-ACK

In some embodiments, the 12 (e)LCID values can be reserved in between (2¹⁶+328) to (2¹⁶+383). One example of such a reservation of 12 (e)LCID values is shown in Table 1. It should be understood, however, that the order in which 12 (e)LCID values are mapped for various purposes can be different than those indicated in table 1. All possible combinations are not listed for brevity.

TABLE 1

| Codepoint | Index | LCID values |
|---|---|---|
| 0 | (2¹⁶ + 320) | CCCH of size 48 bits for an eRedCap UE |
| 1 | (2¹⁶ + 321) | CCCH of size 64 bits for an eRedCap UE |
| 2 | (2¹⁶ + 322) | CCCH of size 48 bits for PUCCH repetition of Msg4 |
| | | HARQ-ACK, except for an (e)RedCap UE |
| 3 | (2¹⁶ + 323) | CCCH of size 64 bits for PUCCH repetition of Msg4 |
| | | HARQ-ACK, except for an (e)RedCap UE |
| 4 | (2¹⁶ + 324) | CCCH of size 48 bits for PUCCH repetition of Msg4 |
| | | HARQ-ACK of a RedCap UE |
| 5 | (2¹⁶ + 325) | CCCH of size 64 bits for PUCCH repetition of Msg4 |
| | | HARQ-ACK of a RedCap UE |
| 6 | (2¹⁶ + 326) | CCCH of size 48 bits for PUCCH repetition of Msg4 |
| | | HARQ-ACK of an eRedCap UE |
| 7 | (2¹⁶ + 327) | CCCH of size 64 bits for PUCCH repetition of Msg4 |
| | | HARQ-ACK of an eRedCap UE |
| 8 | (2¹⁶ + 328) | CCCH of size 48 bits for Msg5 PUSCH repetition, except |
| | | for an (e)RedCap UE |
| 9 | (2¹⁶ + 329) | CCCH of size 64 bits for Msg5 PUSCH repetition, except |
| | | for an (e)RedCap UE |
| 10 | (2¹⁶ + 330) | CCCH of size 48 bits for Msg5 PUSCH repetition of a |
| | | RedCap UE |
| 11 | (2¹⁶ + 331) | CCCH of size 64 bits for Msg5 PUSCH repetition of a |
| | | RedCap UE |
| 12 | (2¹⁶ + 332) | CCCH of size 48 bits for Msg5 PUSCH repetition of an |
| | | eRedCap UE |
| 13 | (2¹⁶ + 333) | CCCH of size 64 bits for Msg5 PUSCH repetition of an |
| | | eRedCap UE |
| 14 | (2¹⁶ + 334) | CCCH of size 48 bits for PUCCH repetition of Msg4 |
| | | HARQ-ACK and Msg5 PUSCH repetition, except for an |
| | | (e)RedCap UE |
| 15 | (2¹⁶ + 335) | CCCH of size 64 bits for PUCCH repetition of Msg4 |
| | | HARQ-ACK and Msg5 PUSCH repetition, except for an |
| | | (e)RedCap UE |
| 16 | (2¹⁶ + 336) | CCCH of size 48 bits for PUCCH repetition of Msg4 |
| | | HARQ-ACK and Msg5 PUSCH repetition, for a RedCap |
| | | UE |
| 17 | (2¹⁶ + 337) | CCCH of size 64 bits for PUCCH repetition of Msg4 |
| | | HARQ-ACK and Msg5 PUSCH repetition, for a RedCap |
| | | UE |
| 18 | (2¹⁶ + 338) | CCCH of size 48 bits for PUCCH repetition of Msg4 |
| | | HARQ-ACK and Msg5 PUSCH repetition, for a |
| | | eRedCap UE |
| 19 | (2¹⁶ + 339) | CCCH of size 64 bits for PUCCH repetition of Msg4 |
| | | HARQ-ACK and Msg5 PUSCH repetition, for a |
| | | eRedCap UE |
| 20 to 63 | (2¹⁶ + 340) to | Reserved |
| | (2¹⁶ + 383) | |

NOTE 1:
The MAC entity may use the code point corresponding to a given feature or feature combination in Table only if network indicates support for the corresponding feature or feature combination.
NOTE 2:
CCCH of size 48 bits and CCCH of size 64 bits are referred to as CCCH and CCCH1, respectively
NOTE 3:
For UE capable of PUCCH repetition of Msg4 HARQ-ACK, the MAC entity uses the code points corresponding to PUCCH repetition of Msg4 HARQ-ACK if numberOfMsg4HARQ-ACK-Repetitions is configured, and if rsrp-ThresholdMsg4HARQ-ACK is configured, the RSRP of the downlink pathloss reference is less than rsrp-ThresholdMsg4HARQ-ACK.

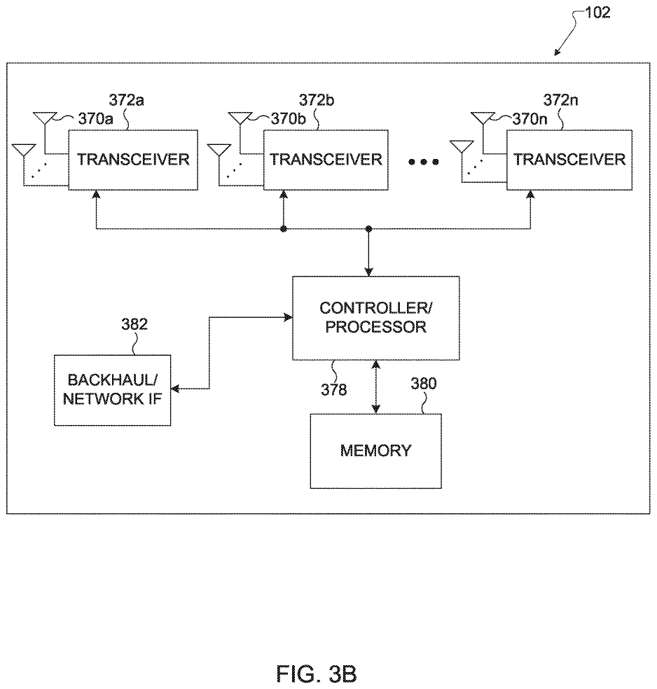

FIGS. 4A and 4B illustrate an example UE procedure for indicating to a gNB a UE capability of supporting Msg5 PUSCH repetition scheduled by DCI format 0_0 with CRC scrambled by C-RNTI 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a UE procedure for indicating to a gNB a UE capability of supporting Msg5 PUSCH repetition scheduled by DCI format 0_0 with CRC scrambled by C-RNTI could be used without departing from the scope of this disclosure.

In the example of FIGS. 4A and 4B, the procedure 400 begins at step 405. At step 405, a UE (such as UE 116 of FIG. 1) is in RRC_IDLE/RRC_INACTIVE state, and the UE supports Msg5 PUSCH repetition scheduled by DCI format 0_0 with CRC scrambled by C-RNTI. The UE initiates connection setup/resume procedure.

At operation 410, the UE includes a CCCH message in a MAC subPDU of a MAC PDU.

At operation 415, the UE selects an (e)LCID value amongst the twelve reserved (e)LCID values based on the UE type and its capability to support PUCCH repetition of Msg4 HARQ-ACK or not.

At operation 420, if the size of the CCCH Message is 48 bits, and the UE is an eRedCap UE, and the UE supports Msg5 PUSCH repetition, and the UE supports PUCCH repetition of Msg4 HARQ-ACK, the UE selects the first (e)LCID.

At operation 425, if the size of the CCCH Message is 64 bits, and the UE is an eRedCap UE, and the UE supports Msg5 PUSCH repetition, and the UE supports PUCCH repetition of Msg4 HARQ-ACK, the UE selects the second (e)LCID.

At operation 430, if the size of the CCCH Message is 48 bits, and the UE is a RedCap UE, and the UE supports Msg5 PUSCH repetition, and the UE supports PUCCH repetition of Msg4 HARQ-ACK, the UE selects the third (e)LCID.

At operation 435, if the size of the CCCH Message is 64 bits, and the UE is a RedCap UE, and the UE supports Msg5 PUSCH repetition, and the UE supports PUCCH repetition of Msg4 HARQ-ACK, the UE selects the fourth (e)LCID.

At operation 440, if the size of the CCCH Message is 48 bits, and the UE is neither a RedCap nor eRedCap UE, and the UE supports Msg5 PUSCH repetition, and the UE supports PUCCH repetition of Msg4 HARQ-ACK, the UE selects the fifth (e)LCID.

At operation 445, if the size of the CCCH Message is 64 bits, and the UE is neither a RedCap nor eRedCap UE, and the UE supports Msg5 PUSCH repetition, and the UE supports PUCCH repetition of Msg4 HARQ-ACK, the UE selects the sixth (e)LCID.

At operation 450, if the size of the CCCH Message is 48 bits, and the UE is an eRedCap UE, and the UE supports Msg5 PUSCH repetition, the UE selects the seventh (e)LCID

At operation 455, if the size of the CCCH Message is 64 bits, and the UE is an eRedCap UE, and the UE supports Msg5 PUSCH repetition, the UE selects the eighth (e)LCID.

At operation 460, if the size of the CCCH Message is 48 bits, and the UE is a RedCap UE, and the UE supports Msg5 PUSCH repetition, the UE selects the nineth (e)LCID.

At operation 465, if the size of the CCCH Message is 64 bits, and the UE is a RedCap UE, and the UE supports Msg5 PUSCH repetition, the UE selects the tenth (e)LCID.

At operation 470, if the size of the CCCH Message is 48 bits, and the UE is neither a RedCap nor eRedCap UE, and the UE supports Msg5 PUSCH repetition, the UE selects the eleventh (e)LCID.

At operation 475, if the size of the CCCH Message is 64 bits, and the UE is neither a RedCap nor eRedCap UE, and the UE supports Msg5 PUSCH repetition, the UE selects the twelfth (e)LCID.

At operation 480, the UE sets the field LX in a MAC subheader of the CCCH MAC subPDU to 1. The UE sets the R bit to 0.

At operation 485, the UE sets the field LCID (6 bits) in the MAC subheader of the CCCH MAC subPDU to a codepoint corresponding to the selected (e)LCID value.

At operation 490, the UE transmits the MAC PDU including the CCCH MAC subPDU and the MAC subheader to a gNB (such as gNB 102 of FIG. 1). MAC PDU may be transmitted in PUSCH (Msg3) during the random access procedure (e.g., initiated for connection setup/resume).

The network determines the UE capability based on the received MAC PDU and accordingly schedules the UE with Msg5 PUSCH repetition (or an UL grant for Msg5 PUSCH repetition). The UE then transmits Msg5 with repetition.

Although FIG. 4 illustrates one example UE procedure for indicating to a gNB a UE capability of supporting Msg5 PUSCH repetition scheduled by DCI format 0_0 with CRC scrambled by C-RNTI 400, various changes may be made to FIG. 4. For example, while shown as a series of operations, various operations in FIG. 4 could overlap, occur in parallel, occur in a different order, occur any number of times, be omitted, or replaced by other operations.

Alternatively, in some embodiments, 4 (e)LCID values (e.g., from the extended LCID space) can be reserved for UE Msg5 PUSCH repetition scheduled by DCI format 0_0 with CRC scrambled by C-RNTI. In embodiments, such as these, an (e)LCID is reserved for each of the following:
a CCCH of size 48 bits for a UE supporting Msg5 PUSCH repetition, except for an (e)RedCap UE
a CCCH of size 64 bits for a UE supporting Msg5 PUSCH repetition, except for an (e)RedCap UE
a CCCH of size 48 bits for a UE supporting Msg5 PUSCH repetition and PUCCH repetition of a Msg4 HARQ-ACK, except for an (e)RedCap UE
a CCCH of size 64 bits for a UE supporting Msg5 PUSCH repetition and PUCCH repetition of a Msg4 HARQ-ACK, except for an (e)RedCap UE.

One example of reservation of these 4 (e)LCID values is shown in Table 2. It should be understood, however, that the order in which these 4 (e)LCID values are mapped for various purposes can be different than those indicated in table 2. All possible combinations are not listed for brevity.

TABLE 2

| Codepoint | Index | LCID values |
|---|---|---|
| 0 | (2¹⁶ + 320) | CCCH of size 48 bits for an eRedCap UE |
| 1 | (2¹⁶ + 321) | CCCH of size 64 bits for an eRedCap UE |
| 2 | (2¹⁶ + 322) | CCCH of size 48 bits for PUCCH repetition of Msg4 |
| | | HARQ-ACK, except for an (e)RedCap UE |
| 3 | (2¹⁶ + 323) | CCCH of size 64 bits for PUCCH repetition of Msg4 |
| | | HARQ-ACK, except for an (e)RedCap UE |
| 4 | (2¹⁶ + 324) | CCCH of size 48 bits for PUCCH repetition of Msg4 |
| | | HARQ-ACK of a RedCap UE |
| 5 | (2¹⁶ + 325) | CCCH of size 64 bits for PUCCH repetition of Msg4 |
| | | HARQ-ACK of a RedCap UE |
| 6 | (2¹⁶ + 326) | CCCH of size 48 bits for PUCCH repetition of Msg4 |
| | | HARQ-ACK of an eRedCap UE |
| 7 | (2¹⁶ + 327) | CCCH of size 64 bits for PUCCH repetition of Msg4 |
| | | HARQ-ACK of an eRedCap UE |
| 8 | (2¹⁶ + 328) | CCCH of size 48 bits for Msg5 PUSCH repetition, except |
| | | for an (e)RedCap UE |
| 9 | (2¹⁶ + 329) | CCCH of size 64 bits for Msg5 PUSCH repetition, except |
| | | for an (e)RedCap UE |
| 14 | (2¹⁶ + 330) | CCCH of size 48 bits for PUCCH repetition of Msg4 |
| | | HARQ-ACK and Msg5 PUSCH repetition, except for an |
| | | (e)RedCap UE |
| 15 | (2¹⁶ + 331) | CCCH of size 64 bits for PUCCH repetition of Msg4 |
| | | HARQ-ACK and Msg5 PUSCH repetition, except for an |
| | | (e)RedCap UE |
| 20 to 63 | (2¹⁶ + 332) to | Reserved |
| | (2¹⁶ + 383) | |

NOTE 1:
The MAC entity may use the code point corresponding to a given feature or feature combination in Table only if network indicates support for the corresponding feature or feature combination.
NOTE 2:
CCCH of size 48 bits and CCCH of size 64 bits are referred to as CCCH and CCCH1, respectively
NOTE 3:
For UE capable of PUCCH repetition of Msg4 HARQ-ACK, the MAC entity uses the code points corresponding to PUCCH repetition of Msg4 HARQ-ACK if numberOfMsg4HARQ-ACK-Repetitions is configured, and if rsrp-ThresholdMsg4HARQ-ACK is configured, the RSRP of the downlink pathloss reference is less than rsrp-ThresholdMsg4HARQ-ACK.

In some embodiments, the UE selects an (e)LCID value amongst the 4 reserved (e)LCID values based on the UE type and its capability to support PUCCH repetition of Msg4 HARQ-ACK or not.

If the size of the CCCH Message is 48 bits and the UE is neither a RedCap nor eRedcap UE, and the UE supports Msg5 PUSCH repetition, and the UE supports PUCCH repetition of Msg4 HARQ-ACK, the UE selects the first (e)LCID.

If the size of the CCCH Message is 64 bits, and the UE is neither a RedCap nor eRedcap UE, and the UE supports Msg5 PUSCH repetition, and the UE supports PUCCH repetition of Msg4 HARQ-ACK, the UE selects the second (e)LCID.

If the size of the CCCH Message is 48 bits, and the UE is neither a RedCap nor eRedcap UE, and the UE supports Msg5 PUSCH repetition, the UE selects the third (e)LCID.

If the size of the CCCH Message is 64 bits, and the UE is neither a RedCap nor eRedcap UE, and the UE supports Msg5 PUSCH repetition, the UE selects the fourth (e)LCID.

The UE sets the field LX in the MAC subheader of the CCCH MAC subPDU to 1. The UE sets the R bit to 0.

The UE sets the field LCID (6 bits) in MAC subheader of the CCCH MAC subPDU to a codepoint corresponding to the selected (e)LCID value.

The UE transmits the MAC PDU including the CCCH MAC subPDU and the MAC subheader to the gNB. The MAC PDU may be transmitted in a PUSCH (Msg3) during the random access procedure (e.g., initiated for connection setup/resume).

The network determines the UE capability based on the received MAC PDU and accordingly schedules the UE with Msg5 PUSCH repetition (or an UL grant for Msg5 PUSCH repetition). The UE then transmits Msg5 with repetition.

Alternatively, in some embodiment, the (e)LCIDs to be served for the case PUCCH repetition of Msg4 and Msg5 PUSCH repetition capability is the same. In embodiments such as these, 6 (e)LCID values from the extended LCID space can be reserved for UE Msg5 PUSCH repetition scheduled by DCI format 0_0 with CRC scrambled by C-RNTI. An (e)LCID is reserved for each of the following:
a CCCH of size 48 bits for PUCCH repetition of Msg4 HARQ-ACK and Msg5 PUSCH repetition, except for an (e)RedCap UE
a CCCH of size 64 bits for PUCCH repetition of Msg4 HARQ-ACK and Msg5 PUSCH repetition, except for an (e)RedCap UE
a CCCH of size 48 bits for PUCCH repetition of Msg4 HARQ-ACK and Msg5 PUSCH repetition of a RedCap UE
a CCCH of size 64 bits for PUCCH repetition of Msg4 HARQ-ACK and Msg5 PUSCH repetition of a RedCap UE
a CCCH of size 48 bits for PUCCH repetition of Msg4 HARQ-ACK and Msg5 PUSCH repetition of an eRedCap UE
a CCCH of size 64 bits for PUCCH repetition of Msg4 HARQ-ACK and Msg5 PUSCH repetition of an eRedCap UE

Alternatively, in some embodiments, the (e)LCIDs to be served for the case of PUCCH repetition of Msg4 and Msg5 PUSCH repetition capability is the same and Msg5 PUSCH repetition is not applied to (e)redcap. In embodiments such as these, 2 (e)LCID values from the extended LCID space can be reserved for UE Msg5 PUSCH repetition scheduled by DCI format 0_0 with CRC scrambled by C-RNTI. An (e)LCID is reserved for each of the following:
a CCCH of size 48 bits for PUCCH repetition of Msg4 HARQ-ACK and Msg5 PUSCH repetition, except for an (e)RedCap UE
a CCCH of size 64 bits for PUCCH repetition of Msg4 HARQ-ACK and Msg5 PUSCH repetition, except for an (e)RedCap UE.

In some embodiment, a new MAC CE can be defined or Msg5 PUSCH repetition capability. In embodiments cush as these, this new MAC CE is included in a Msg3 MAC PDU. This MAC PDU may also include CCCH SDU. This new MAC CE may just be a MAC subheader with no payload where one LCID is reserved to identify this new MAC CE. The LCID may be served from a table corresponding to LX=1 or the LCID may be served from a table corresponding to LX=0. The network determines the UE capability based on the received MAC PDU and accordingly schedules the UE with Msg5 PUSCH repetition (or UL grant for Msg5 PUSCH repetition). The UE then transmits Msg5 with repetition.

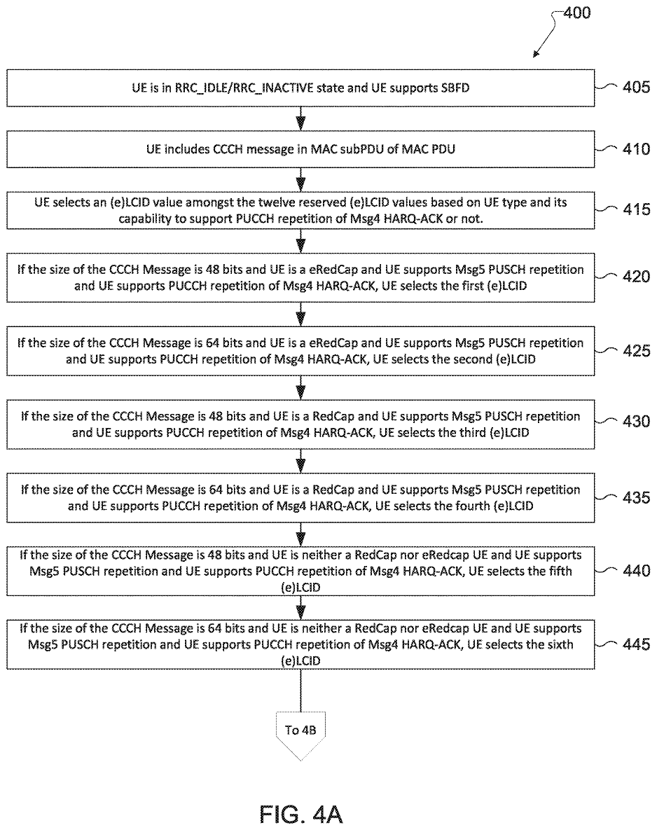

In an alternate embodiment, a new MAC CE can be defined for all capabilities indicated via Msg3/MsgA, similar as shown in FIG. 5

FIG. 5 illustrates an example MAC CE 500 according to embodiments of the present disclosure. The embodiment of a MAC CE of FIG. 5 is for illustration only. Different embodiments of a MAC CE could be used without departing from the scope of this disclosure.

In the example of FIG. 5, the payload of the MAC CE 500 includes a bit map, wherein each bit corresponds to different capability (e.g., redcap, eredcap, PUCCH repetition of Msg4 HARQ-ACK, Msg5 PUSCH repetition etc.). An LCID may be served from table corresponding to LX=1 or an LCID may be served from a table corresponding to LX=0. The payload can be fixed size (for example, example 8 or 16 bits or any other number of bits).

Although FIG. 5 illustrates one example a MAC CE 500, various changes may be made to FIG. 5. For example, various changes to the bit arrangement could be made, etc., according to particular needs.

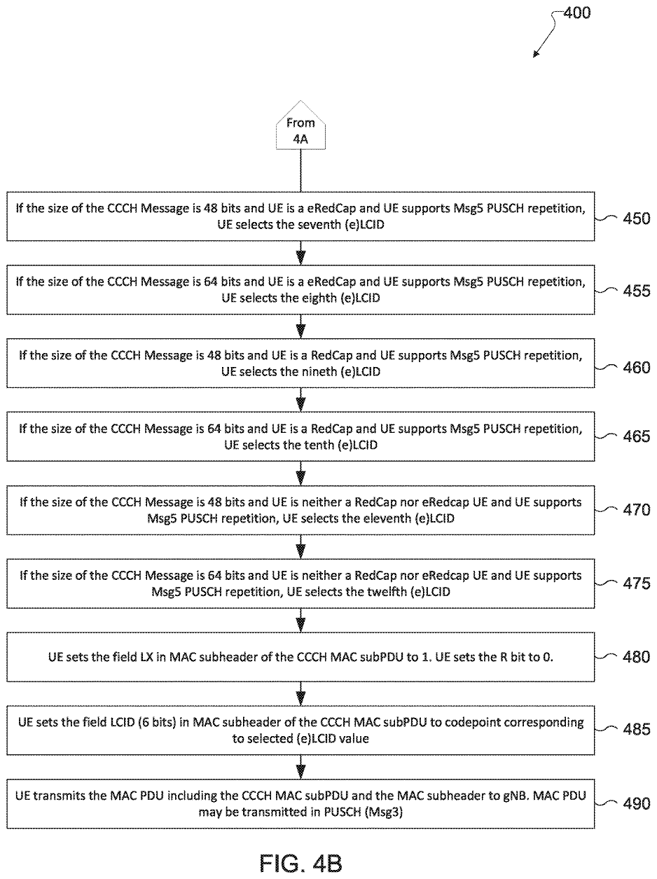

In some embodiments, a MAC CE payload can also be variable size, similar as shown in FIG. 6.

FIG. 6 illustrates an example MAC CE payload 600 according to embodiments of the present disclosure. The embodiment of a MAC CE payload of FIG. 6 is for illustration only. Different embodiments of a MAC CE payload could be used without departing from the scope of this disclosure.

In the example of FIG. 6, the payload is a variable size. Alternately, the payload can also be a variable size with at least one octet. A Bit (C) in the octet(s) is mapped to a different capability (e.g., redcap, eredcap, PUCCH repetition of Msg4 HARQ-ACK, Msg5 PUSCH repetition etc.). A bit not mapped to any capability in the octets can be an R bit. Each octet in the MAC CE can have an E bit which indicates (e.g., by setting E bit to 1) whether another octet follows this octet.

Although FIG. 6 illustrates one example MAC CE payload 600, various changes may be made to FIG. 6. For example, various changes to the number of octets could be made, etc., according to particular needs.

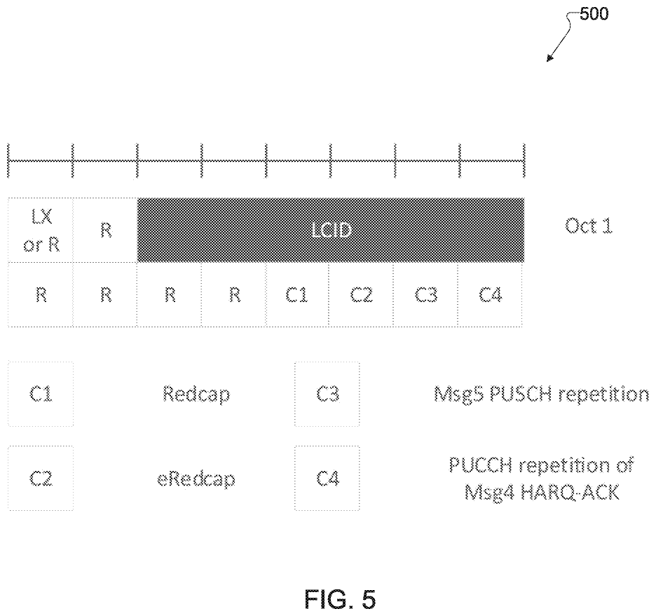

In some embodiments, a capability header can be defined which is present at the beginning or end of a Msg 3/MsgA MAC PDU, similar as shown in FIG. 7. The capability header can be always present or whether to include the capability header can be indicated in a Msg2 (DCI or MAC PDU/MAC RAR) or in SI or in a RACH configuration by the gNB. The capability header can be fixed size or variable size (an E bit can indicate presence of additional octet in the header). An example of this header is shown in FIG. 7 below.

FIG. 7 illustrates an example MAC PDU capability header 700 according to embodiments of the present disclosure. The embodiment of a MAC PDU capability header of FIG. 7 is for illustration only. Different embodiments of a MAC PDU capability header could be used without departing from the scope of this disclosure.

In the example of FIG. 7, each bit (C) in an octet can be mapped to a different capability (e.g., RedCap, eRedCap, PUCCH repetition of Msg4 HARQ-ACK, Msg5 PUSCH repetition etc.). For example, one bit can be mapped to indicate Msg5 PUSCH repetition. A bit not mapped to any capability in the octet(s) can be an R bit.

Although FIG. 7 illustrates one example MAC PDU capability header, various changes may be made to FIG. 7. For example, various changes to the number of octets could be made, etc., according to particular needs.

In some embodiments, a 1 bit indication can be included in an RRC message transmitted in Msg3 (e.g., an RRCResumeRequest/RRCSetupRequest) to indicate Msg5 PUSCH repetition capability. In one example, as shown below, a spare bit can be used for this indication.

```
RRCSetupRequest-IEs ::= SEQUENCE {
  ue-Identity InitialUE-Identity,
  establishmentCause EstablishmentCause,
  spare BIT STRING (SIZE (1))
}
RRCResumeRequest-IEs ::= SEQUENCE {
  resumeIdentity ShortI-RNTI-Value,
  resumeMAC-I BIT STRING (SIZE (16)),
  resumeCause ResumeCause,
  spare BIT STRING (SIZE (1))
}
RRCResumeRequest1-IEs ::= SEQUENCE {
  resumeIdentity I-RNTI-Value,
  resumeMAC-I BIT STRING (SIZE (16)),
  resumeCause ResumeCause,
  spare BIT STRING (SIZE (1))
}
```

In some embodiments, a new Establishment/Resume cause in an RRC message can be transmitted in Msg3 (e.g., and RRCResumeRequest/RRCSetupRequest) using spare code points which can be included for msg5 PUSCH repetition indication, similar as shown below.

```
EstablishmentCause ::= ENUMERATED {
  emergency, highPriorityAccess, mt-Access, mo-Signalling,
  mo-Data, mo-VoiceCall, mo-VideoCall, mo-SMS, mps-
Priority Access, mcs-Priority Access,
  spare6, spare5, spare4, spare3, spare2, spare1}
ResumeCause ::= ENUMERATED {emergency, highPriorityAccess, mt-
Access, mo-Signalling,
  mo-Data, mo-VoiceCall, mo-VideoCall, mo-SMS, rna-Update, mps-
Priority Access,
  mcs-Priority Access, mt-SDT-v1810, srs-PosConfigOrActivationReq-
v1800, spare3, spare2, spare1 }
```

In some embodiments, a new RRCResumeRequest2 (whose format is the same as RRCResumeRequest1), RRCResumeRequest3 (whose format is the same as RRCResumeRequest2) and RRCConnectionSetup1 (whose format is same as RRCConnectionSetup) using spare code points as shown below can be defined, similar as shown below. The UE uses RRCResumeRequest2/RRCResumeRequest3/RRCConnectionSetup1 instead of RRCResumeRequest/RRCResumeRequest1/RRCConnectionSetup if UE is capable of Msg5 PUSCH repetition.

```
UL-CCCH1-Message ::= SEQUENCE {
  message UL-CCCH1-Message Type
}
UL-CCCH1-MessageType ::= CHOICE {
  c1 CHOICE {
    rrcResumeRequest1 RRCResumeRequest1,
    spare3 NULL,
    spare2 NULL,
    spare1 NULL
    },
    messageClassExtension SEQUENCE { }
}
```

As noted above, various embodiments of the present disclosure provide mechanisms for UE PUCCH/PUSCH transmission if the UE is not UL synchronized.

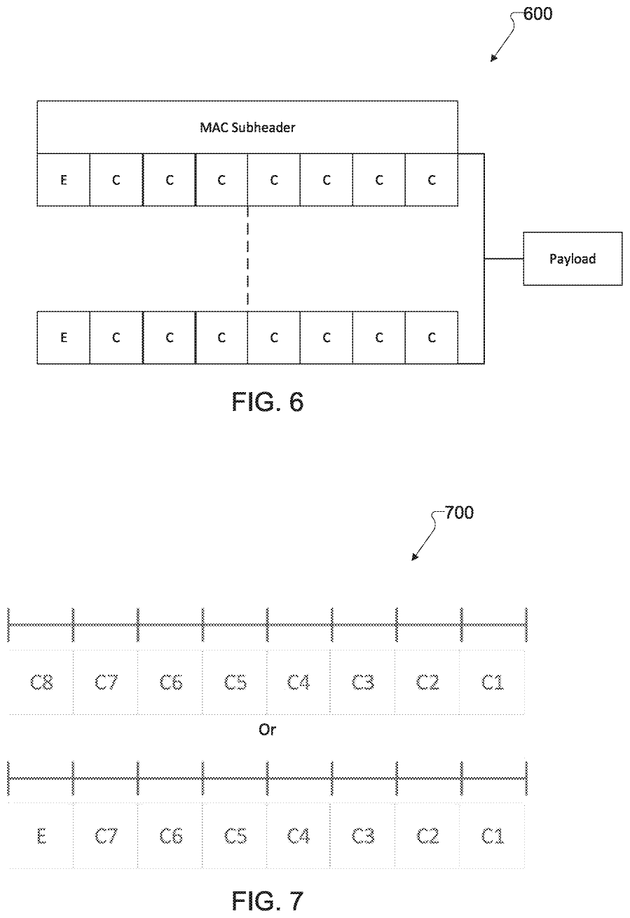

FIG. 8 illustrates an example procedure for UE triggered beam reporting 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for UE triggered beam reporting could be used without departing from the scope of this disclosure.

In the example of FIG. 8, the procedure 800 begins at operation 810. At operation 810, a UE (such as UE 116 of FIG. 1), which may be in an RRC_CONNECTED state, may indicate/signal to a gNB (such as gNB 102 of FIG. 1) that the UE supports UE initiated (or event triggered) beam reporting. This capability may be signaled per UE (which means that the UE supports or does not support this capability irrespective of any frequency band). Alternately, this capability may be signaled per frequency band (or per FR1/FR2 etc.) wherein the UE may support this for some frequency bands or all of them or none of them. Alternately, this capability may be signaled per frequency band combination. Alternately, this capability may be signaled per band per band combination. Alternately, this capability may be signaled per component carrier per band per band combination (feature set per component carrier). In some embodiments, this capability may be signaled by the UE to the gNB via a RRC message (e.g., a UE capability information message, RRC Resume Complete message, RRC connection setup complete message or any new message). In some embodiments, this capability may be signaled by the UE to the gNB upon receiving a request from the gNB. In some embodiments, this capability may be signaled by the UE to the gNB upon entering an RRC_CONNECTED state. In some embodiments, this capability may be signaled by the UE to the gNB when the UE is configured with a serving cell with multiple beams (or RSs QCLed with beams/SSBs).

At operation 820, the UE receives an RRCReconfiguration message from gNB. The message includes a configuration of one or more RSs for UE initiated (or event triggered) beam reporting for one or more serving cells. The message includes PUCCH resources for transmitting UCI for mode A based UE initiated (or event triggered) beam reporting. These PUCCH resources can be for an SpCell (i.e., a PCell in the case of a MCG or PSCell in the case of an SCG or PUCCH SCell).

At operation 830, the UE performs the measurement (i.e., measures L1-RSRPs/RSRQs/SINRs, etc. as configured, of the configured RSs for UE initiated [or event triggered] beam reporting). For SCells, the UE may measure only if the SCell is activated.

At operation 840, a UE initiated (or event triggered) beam reporting is triggered for a serving cell.

At operation 850, the UE checks whether it is UL synchronized (e.g., whether it has valid TA) for a serving cell (i.e., a serving cell for which PUCCH resources for transmitting UCI for mode A based UE initiated [or event triggered] beam reporting are configured) to which the UE needs to transmit UCI over a PUCCH for UE initiated (or event triggered) beam reporting.

Note that the UE is considered not UL synchronized for a serving cell in a cell group when the timeAlignmentTimer(s) associated with all PTAG(s) of the cell group are not running. The UE is considered not UL synchronized for a serving cell in cell group when the time AlignmentTimer(s) associated with all TAG(s) of the serving cell are not running.

At operation 860, if the UE is UL synchronized for the serving cell (i.e., the serving cell for which PUCCH resources for transmitting UCI for mode A based UE initiated (or event triggered) beam reporting are configured) to which the UE needs to transmit UCI over PUCCH for UE initiated (or event triggered) beam reporting:
The UE transmits UCI on a PUCCH to the serving cell.
The UE then receives UL grant (PUSCH). The UE transmits the UE initiated (or event triggered) beam report in the UL grant.

In some embodiments, at operation 870, if the UE is not UL synchronized for the serving cell (i.e., the serving cell for which PUCCH resources for transmitting UCI for mode A based UE initiated (or event triggered) beam reporting are configured) to which the UE needs to transmit UCI over PUCCH for UE initiated (or event triggered) beam reporting:
The UE initiates a random access procedure towards the SpCell
   In some embodiments, the UE transmits the UE initiated (or event triggered) beam report in an UL grant for Msg3/MsgA during the random access procedure.
   Alternatively, in some embodiments, the UE receives an UL grant after transmitting the Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the this PDCCH is received after completion of the RA procedure.

Alternatively, in some embodiments, at operation 870, if the UE is not UL synchronized for the serving cell (i.e., the serving cell for which PUCCH resources for transmitting UCI for mode A based UE initiated (or event triggered) beam reporting are configured) to which the UE needs to transmit UCI over PUCCH for UE initiated (or event triggered) beam reporting:
The UE initiates a random access procedure towards the SpCell.
In some embodiments,
   The UE includes the UE initiated (or event triggered) beam report indication in an UL grant for Msg3/MsgA during the random access procedure. The beam report indication can be in an RRC message or a MAC CE or a MAC subheader or a MAC subPDU included in the UL grant. The beam report indication can be implicit based on an LCID/eLCID reserved for indicating the beam report indication wherein this LCID/eLCID is included in the MAC subheader of a MAC CE or a MAC subPDU in the Msg3/MsgA. For example, the MAC CE can be a C-RNTI MAC CE including this LCID/eLCID reserved for indicating the beam report indication in the MAC subheader. In another example, the MAC CE can be a new MAC CE including this LCID/eLCID reserved for indicating the beam report indication in the MAC subheader.
   The UE receives an UL grant after transmitting the Msg3/MsgA and the UE transmits a UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the PDCCH is received after completion of the RA procedure.
Alternatively, in some embodiments,
   The UE indicates the UE initiated (or event triggered) beam report indication via a random access preamble by selecting the RO/preamble from ROs/preambles reserved for the UE initiated (or event triggered) beam report indication during the random access procedure. The ROs/preambles reserved for the UE initiated (or event triggered) beam report indication can be received by the UE from the base station in SI or an RRC message.
   The UE then transmits the UE initiated (or event triggered) beam report in a Msg3 or MsgA.

Although FIG. 8 illustrates one example procedure for UE triggered beam reporting 800, various changes may be made to FIG. 8. For example, while shown as a series of operations, various operations in FIG. 8 could overlap, occur in parallel, occur in a different order, occur any number of times, be omitted, or replaced by other operations.

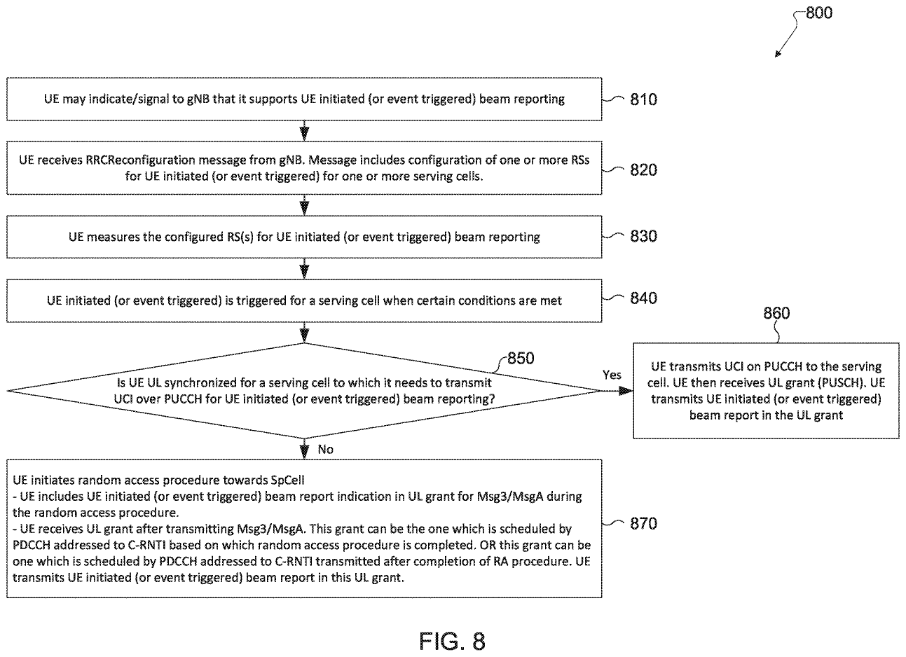

FIG. 9 illustrates another example procedure for UE triggered beam reporting 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for UE triggered beam reporting could be used without departing from the scope of this disclosure.

In the example of FIG. 9, the procedure 900 begins at operation 910. At operation 910, a UE (such as UE 116 of FIG. 1), which may be in an RRC_CONNECTED state, may indicate/signal to a gNB (such as gNB 102 of FIG. 1) that the UE supports UE initiated (or event triggered) beam reporting. This capability may be signaled per UE (which means that the UE supports or does not support this capability irrespective of any frequency band). Alternately, this capability may be signaled per frequency band (or per FR1/FR2 etc.) wherein the UE may support this for some frequency bands or all of them or none of them. Alternately, this capability may be signaled per frequency band combination. Alternately, this capability may be signaled per band per band combination. Alternately, this capability may be signaled per component carrier per band per band combination (feature set per component carrier). In some embodiments, this capability may be signaled by the UE to the gNB via a RRC message (e.g., a UE capability information message, RRC Resume Complete message, RRC connection setup complete message or any new message). In some embodiments, this capability may be signaled by the UE to the gNB upon receiving a request from the gNB. In some embodiments, this capability may be signaled by the UE to the gNB upon entering an RRC_CONNECTED state. In some embodiments, this capability may be signaled by the UE to the gNB when the UE is configured with a serving cell with multiple beams (or RSs QCLed with beams/SSBs).

At operation 920, the UE receives an RRCReconfiguration message from gNB. The message includes a configuration of one or more RSs for UE initiated (or event triggered) beam reporting for one or more serving cells. The message includes PUCCH resources for transmitting UCI for mode A based UE initiated (or event triggered) beam reporting. These PUCCH resources can be for an SpCell (i.e., a PCell in the case of a MCG or PSCell in the case of an SCG or PUCCH SCell).

At operation 930, the UE performs the measurement (i.e., measures L1-RSRPs/RSRQs/SINRs, etc. as configured, of the configured RSs for UE initiated [or event triggered] beam reporting). For SCells, the UE may measure only if the SCell is activated.

At operation 940, a UE initiated (or event triggered) beam reporting is triggered for a serving cell.

At operation 950, the UE checks whether it has a valid PUCCH resource for transmitting UCI for mode A based UE initiated (or event triggered) beam reporting.

PUCCH resources configured for transmitting UCI for mode A based UE initiated (or event triggered) beam reporting may be invalid if the UE is not UL synchronized for the serving cell (i.e., the serving cell for which PUCCH resources for transmitting UCI for mode A based UE initiated [or event triggered] beam reporting are configured) to which the UE needs to transmit UCI over a PUCCH for the UE initiated (or event triggered) beam reporting.

At operation 960, if the UE has a valid PUCCH resource for transmitting UCI for mode A based UE initiated (or event triggered) beam reporting:
The UE transmits UCI on a PUCCH to the serving cell.
The UE then receives a UL grant (PUSCH). The UE transmits UE initiated (or event triggered) beam report in the UL grant.

In some embodiments, at operation 970, if the UE does not have a valid PUCCH resource for transmitting UCI for mode A based UE initiated (or event triggered) beam reporting:
The UE initiates a random access procedure towards the SpCell
   In some embodiments, the UE transmits the UE initiated (or event triggered) beam report in a UL grant for Msg3/MsgA during the random access procedure.
   Alternatively, in some embodiments, the UE receives an UL grant after transmitting the Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the this PDCCH is received after completion of the RA procedure.

Alternatively, in some embodiments, at operation 970, if the UE does not have a valid PUCCH resource for transmitting UCI for mode A based UE initiated (or event triggered) beam reporting:
The UE initiates a random access procedure towards SpCell.
In some embodiments,
   The UE includes the UE initiated (or event triggered) beam report indication in an UL grant for Msg3/MsgA during the random access procedure. The beam report indication can be in an RRC message or a MAC CE or a MAC subheader or a MAC subPDU included in the UL grant. The beam report indication can be implicit based on a LCID/eLCID reserved for indicating the beam report indication wherein this LCID/eLCID is included in the MAC subheader of a MAC CE or a MAC subPDU in the Msg3/MsgA. For example, the MAC CE can be a C-RNTI MAC CE including this LCID/eLCID reserved for indicating the beam report indication in the MAC subheader. In another example, the MAC CE can be a new MAC CE including this LCID/eLCID reserved for indicating the beam report indication in the MAC subheader.
   The UE receives the UL grant after transmitting the Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the PDCCH is received after completion of the RA procedure.
Alternatively, in some embodiments,
   The UE the indicates UE initiated (or event triggered) beam report indication via a random access preamble by selecting the RO/preamble from ROs/preambles reserved for the UE initiated (or event triggered) beam report indication during the random access procedure. The ROs/preambles reserved for the UE initiated (or event triggered) beam report indication can be received by the UE from base station in SI or an RRC message.
      The UE then transmits the UE initiated (or event triggered) beam report in the Msg3 or MsgA.

Although FIG. 9 illustrates one example procedure for UE triggered beam reporting 900, various changes may be made to FIG. 9. For example, while shown as a series of operations, various operations in FIG. 9 could overlap, occur in parallel, occur in a different order, occur any number of times, be omitted, or replaced by other operations.

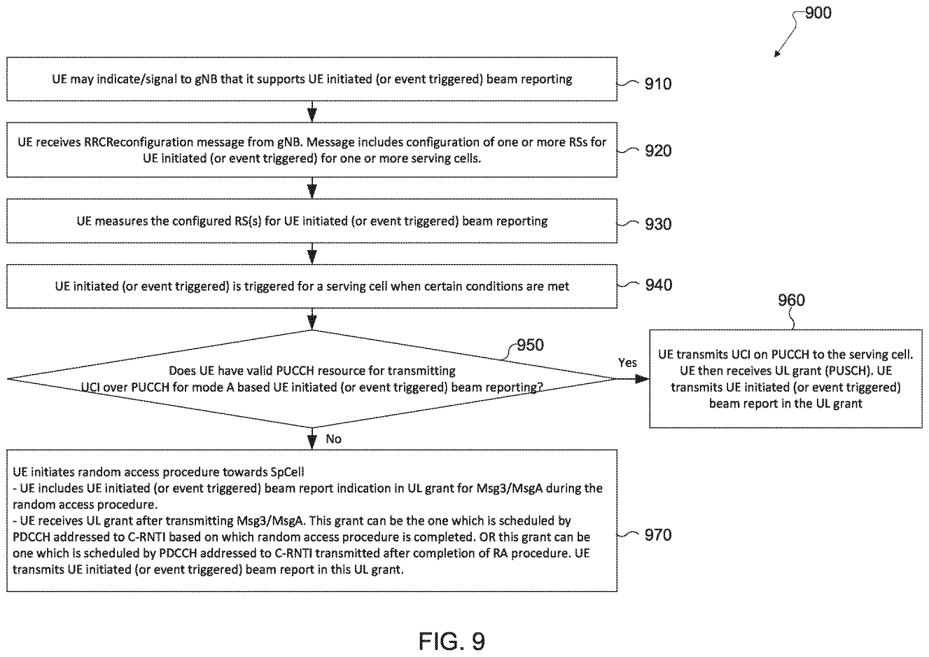

FIG. 10 illustrates another example procedure for UE triggered beam reporting 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for UE triggered beam reporting could be used without departing from the scope of this disclosure.

In the example of FIG. 10, the procedure 1000 begins at operation 1010. At operation 1010, a UE (such as UE 116 of FIG. 1), which may be in an RRC_CONNECTED state, may indicate/signal to a gNB (such as gNB 102 of FIG. 1) that the UE supports UE initiated (or event triggered) beam reporting. This capability may be signaled per UE (which means that the UE supports or does not support this capability irrespective of any frequency band). Alternately, this capability may be signaled per frequency band (or per FR1/FR2 etc.) wherein the UE may support this for some frequency bands or all of them or none of them. Alternately, this capability may be signaled per frequency band combination. Alternately, this capability may be signaled per band per band combination. Alternately, this capability may be signaled per component carrier per band per band combination (feature set per component carrier). In some embodiments, this capability may be signaled by the UE to the gNB via a RRC message (e.g., a UE capability information message, RRC Resume Complete message, RRC connection setup complete message or any new message). In some embodiments, this capability may be signaled by the UE to the gNB upon receiving a request from the gNB. In some embodiments, this capability may be signaled by the UE to the gNB upon entering an RRC_CONNECTED state. In some embodiments, this capability may be signaled by the UE to the gNB when the UE is configured with a serving cell with multiple beams (or RSs QCLed with beams/SSBs).

At operation 1020, the UE receives an RRCReconfiguration message from gNB. The message includes a configuration of one or more RSs for UE initiated (or event triggered) beam reporting for one or more serving cells. The message includes PUCCH resources for transmitting UCI for mode B based UE initiated (or event triggered) beam reporting. These PUCCH resources can be for an SpCell (i.e., a PCell in the case of a MCG or PSCell in the case of an SCG or PUCCH SCell). The message includes CG PUSCH resources for transmitting the beam report for mode B based UE initiated (or event triggered) beam reporting.

At operation 1030, the UE performs the measurement (i.e., measures L1-RSRPs/RSRQs/SINRs, etc. as configured, of the configured RSs for UE initiated [or event triggered] beam reporting). For SCells, the UE may measure only if the SCell is activated.

At operation 1040, a UE initiated (or event triggered) beam reporting is triggered for a serving cell.

At operation 1050, the UE checks whether it is UL synchronized (e.g., whether it has valid TA) for a serving cell to which it needs to transmit a CG PUSCH for mode B based UE initiated (or event triggered) beam reporting (or alternately the UE checks whether it is UL synchronized [e.g., it has valid TA] for a serving cell to which it needs to transmit UCI for mode B based UE initiated [or event triggered] beam reporting).

Note that the UE is considered not UL synchronized for a serving cell in a cell group when the timeAlignmentTimer(s) associated with all PTAG(s) of the cell group are not running. The UE is considered not UL synchronized for a serving cell in cell group when the time AlignmentTimer(s) associated with all TAG(s) of the serving cell are not running.

In some embodiments, at operation 1060, if the UE is UL synchronized (e.g., it has valid TA) for a serving cell to which it needs to transmit a CG PUSCH for mode B based UE initiated (or event triggered) beam reporting (or alternately if the UE is UL synchronized [e.g., it has valid TA] for a serving cell to which it needs to transmit UCI for mode B based UE initiated [or event triggered] beam reporting):
The UE transmits UCI on PUCCH resources configured for Mode B based UE initiated (or event triggered) beam reporting to the serving cell.
The UE then transmits the UE initiated (or event triggered) beam report in the CG PUSCH to the serving cell.

In some embodiments, at operation 1070, if the UE is not UL synchronized (e.g., it has valid TA) for a serving cell to which it needs to transmit a CG PUSCH for mode B based UE initiated (or event triggered) beam reporting (or alternately if the UE is UL synchronized [e.g., it has valid TA] for a serving cell to which it needs to transmit UCI for mode B based UE initiated [or event triggered] beam reporting):
The UE initiates a random access procedure towards the SpCell
   In some embodiments, the UE transmits the UE initiated (or event triggered) beam report in a UL grant for Msg3/MsgA during the random access procedure.
   In an alternate embodiment, the UE receives a UL grant after transmitting a Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the PDCCH is received after completion of RA procedure.

Alternatively, in some embodiments, at operation 1070, if the UE is not UL synchronized (e.g., it has valid TA) for a serving cell to which it needs to transmit a CG PUSCH for mode B based UE initiated (or event triggered) beam reporting (or alternately if the UE is UL synchronized [e.g., it has valid TA] for a serving cell to which it needs to transmit UCI for mode B based UE initiated [or event triggered] beam reporting):
The UE initiates a random access procedure towards the SpCell.
In some embodiments,
   The UE includes the UE initiated (or event triggered) beam report indication in an UL grant for a Msg3/MsgA during the random access procedure. The beam report indication can be in an RRC message or a MAC CE or a MAC subheader or a MAC subPDU included in the UL grant. The beam report indication can be implicit based on a LCID/eLCID reserved for indicating the beam report indication, wherein this LCID/eLCID is included in the MAC subheader of a MAC CE or MAC subPDU in a Msg3/MsgA. For example, the MAC CE can be a C-RNTI MAC CE including this LCID/eLCID reserved for indicating the beam report indication in the MAC subheader. In another example, the MAC CE can be a new MAC CE including this LCID/eLCID reserved for indicating the beam report indication in the MAC subheader.
   The UE receives an UL grant after transmitting a Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the this PDCCH is received after completion of the RA procedure.
Alternatively, in some embodiments,
   The UE indicates the UE initiated (or event triggered) beam report indication via a random access preamble by selecting the RO/preamble from ROs/preambles reserved for the UE initiated (or event triggered) beam report indication during the random access procedure. The ROs/preambles reserved for the UE initiated (or event triggered) beam report indication can be received by the UE from the base station in SI or an RRC message.
   The UE then transmits the UE initiated (or event triggered) beam report in a Msg3 or MsgA.

Alternatively, in some embodiments, at operation 1060, if the UE is UL synchronized (e.g. it has valid TA) for a serving cell (e.g., Cell “A”) to which it needs to transmit a CG PUSCH for mode B based UE initiated (or event triggered) beam reporting and if the UE is not UL synchronized (e.g. it has valid TA) for a serving cell (e.g., Cell “B”) to which it needs to transmit UCI for mode B based UE initiated (or event triggered) beam reporting:
The UE does not transmit UCI on PUCCH resources configured for Mode B based UE initiated (or event triggered) beam reporting to Cell B.
The UE transmits the UE initiated (or event triggered) beam report in the CG PUSCH to the serving cell (i.e., Cell A)

Alternatively, in some embodiments, at operation 1060, if the UE is UL synchronized (e.g. it has valid TA) for a serving cell (e.g., Cell “A”) to which it needs to transmit a CG PUSCH for mode B based UE initiated (or event triggered) beam reporting and if the UE is UL synchronized (e.g. it has valid TA) for a serving cell (e.g., Cell “B”) to which it needs to transmit UCI for mode B based UE initiated (or event triggered) beam reporting:
The UE transmits UCI on PUCCH resources configured for Mode B based UE initiated (or event triggered) beam reporting to Cell B.
The UE then transmits the UE initiated (or event triggered) beam report in the CG PUSCH to the serving cell (i.e., Cell A).

Alternatively, in some embodiments, at operation 1070, if the UE is not UL synchronized (e.g., it has valid TA) for a serving cell to which it needs to transmit a CG PUSCH for mode B based UE initiated (or event triggered) beam reporting (or alternately if the UE is UL synchronized [e.g., it has valid TA] for a serving cell to which it needs to transmit UCI for mode B based UE initiated [or event triggered] beam reporting):
The UE initiates a random access procedure towards the SpCell.
   In some embodiments, the UE transmits a UE initiated (or event triggered) beam report in a UL grant for a Msg3/MsgA during the random access procedure.
   In an alternate embodiment, the UE receives a UL grant after transmitting a Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the PDCCH is received after completion of the RA procedure.

Alternatively, in some embodiments, at operation 1070, if the UE is not UL synchronized (e.g., it has valid TA) for a serving cell to which it needs to transmit a CG PUSCH for mode B based UE initiated (or event triggered) beam reporting (or alternately if the UE is UL synchronized [e.g., it has valid TA] for a serving cell to which it needs to transmit UCI for mode B based UE initiated [or event triggered] beam reporting):
The UE initiates a random access procedure towards the SpCell.
In some embodiments,
   The UE includes the UE initiated (or event triggered) beam report indication in a UL grant for a Msg3/MsgA during the random access procedure. The beam report indication can be in an RRC message or a MAC CE or a MAC subheader or a MAC subPDU included in the UL grant. The beam report indication can be implicit based on an LCID/eLCID reserved for indicating the beam report indication wherein this LCID/eLCID is included in the MAC subheader of a MAC CE or a MAC subPDU in the Msg3/MsgA. For example, the MAC CE can be a C-RNTI MAC CE including this LCID/eLCID reserved for indicating the beam report indication in the MAC subheader. In another example, the MAC CE can be a new MAC CE including this LCID/eLCID reserved for indicating the beam report indication in the MAC subheader.
   The UE receives a UL grant after transmitting the Msg3/MsgA and the UE transmits UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the PDCCH is received after completion of the RA procedure.
Alternatively, in some embodiments,
   The UE indicates the UE initiated (or event triggered) beam report indication via a random access preamble by selecting the RO/preamble from ROs/preambles reserved for the UE initiated (or event triggered) beam report indication during the random access procedure. The ROs/preambles reserved for the UE initiated (or event triggered) beam report indication can be received by the UE from the base station in SI or an RRC message.
      The UE then transmits the UE initiated (or event triggered) beam report in a Msg3 or MsgA.

Although FIG. 10 illustrates one example procedure for UE triggered beam reporting 1000, various changes may be made to FIG. 10. For example, while shown as a series of operations, various operations in FIG. 10 could overlap, occur in parallel, occur in a different order, occur any number of times, be omitted, or replaced by other operations.

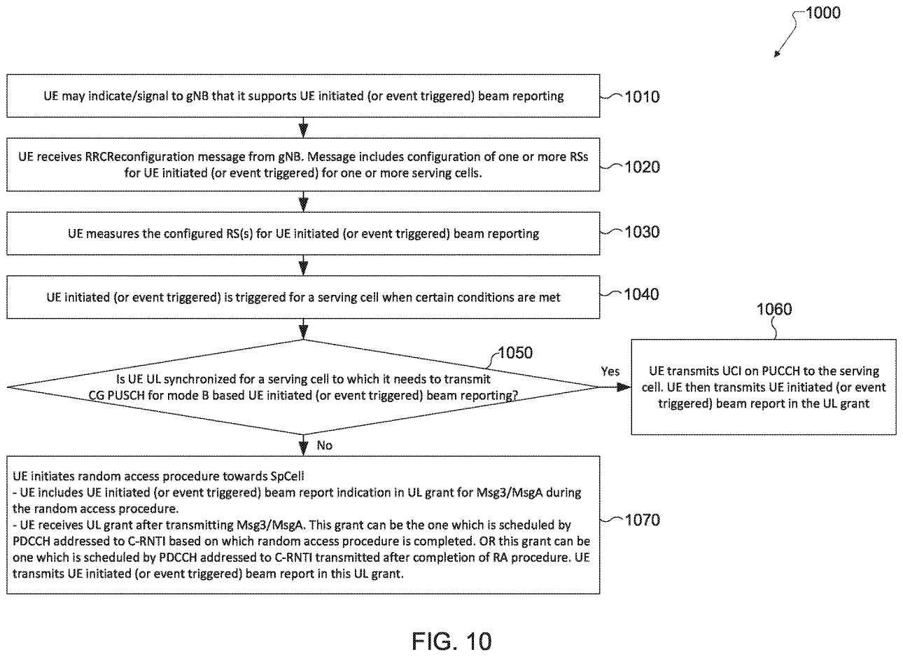

FIG. 11 illustrates another example procedure for UE triggered beam reporting 1100 according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for UE triggered beam reporting could be used without departing from the scope of this disclosure.

In the example of FIG. 11, the procedure 1100 begins at operation 1110. At operation 1110, a UE (such as UE 116 of FIG. 1), which may be in an RRC_CONNECTED state, may indicate/signal to a gNB (such as gNB 102 of FIG. 1) that the UE supports UE initiated (or event triggered) beam reporting. This capability may be signaled per UE (which means that the UE supports or does not support this capability irrespective of any frequency band). Alternately, this capability may be signaled per frequency band (or per FR1/FR2 etc.) wherein the UE may support this for some frequency bands or all of them or none of them. Alternately, this capability may be signaled per frequency band combination. Alternately, this capability may be signaled per band per band combination. Alternately, this capability may be signaled per component carrier per band per band combination (feature set per component carrier). In some embodiments, this capability may be signaled by the UE to the gNB via a RRC message (e.g., a UE capability information message, RRC Resume Complete message, RRC connection setup complete message or any new message). In some embodiments, this capability may be signaled by the UE to the gNB upon receiving a request from the gNB. In some embodiments, this capability may be signaled by the UE to the gNB upon entering an RRC_CONNECTED state. In some embodiments, this capability may be signaled by the UE to the gNB when the UE is configured with a serving cell with multiple beams (or RSs QCLed with beams/SSBs).

At operation 1120, the UE receives an RRCReconfiguration message from gNB. The message includes a configuration of one or more RSs for UE initiated (or event triggered) beam reporting for one or more serving cells. The message includes PUCCH resources for transmitting UCI for mode B based UE initiated (or event triggered) beam reporting. These PUCCH resources can be for an SpCell (i.e., a PCell in the case of a MCG or PSCell in the case of an SCG or PUCCH SCell). The message includes CG PUSCH resources for transmitting the beam report for mode B based UE initiated (or event triggered) beam reporting.

At operation 1130, the UE performs the measurement (i.e., measures L1-RSRPs/RSRQs/SINRs, etc. as configured, of the configured RSs for UE initiated [or event triggered] beam reporting). For SCells, the UE may measure only if the SCell is activated.

At operation 1140, a UE initiated (or event triggered) beam reporting is triggered for a serving cell.

At operation 1150, the UE checks whether it has valid CG PUSCH resources for transmitting a beam report for mode B based UE initiated (or event triggered) beam reporting.

CG PUSCH resources configured for transmitting a beam report for mode B based UE initiated (or event triggered) beam reporting may be invalid if the UE is not UL synchronized for the serving cell (i.e., the serving cell for which the CG PUSCH resources beam report for mode B based UE initiated [or event triggered] beam reporting are configured) to which the UE needs to transmit the beam report over the CG PUSCH for UE initiated (or event triggered) beam reporting.

In some embodiments, at operation 1160, if the UE has valid CG PUSCH resources for transmitting the beam report for mode B based UE initiated (or event triggered) beam reporting:
The UE transmits UCI on PUCCH resources configured for Mode B based UE initiated (or event triggered) beam reporting to the serving cell.
The UE then transmits the UE initiated (or event triggered) beam report in the CG PUSCH to the serving cell.

In some embodiments, at operation 1170, if the UE does not have valid CG PUSCH resources for transmitting beam report for mode B based UE initiated (or event triggered) beam reporting:
The UE initiates a random access procedure towards the SpCell.
   In some embodiments, The UE transmits the UE initiated (or event triggered) beam report in a UL grant for a Msg3/MsgA during the random access procedure.
   Alternatively, in some embodiments, the UE receives a UL grant after transmitting a Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the this PDCCH is received after completion of the RA procedure.

Alternatively, in some embodiments, at operation 1170, if the UE does not have valid CG PUSCH resources for transmitting the beam report for mode B based UE initiated (or event triggered) beam reporting:
The UE initiates a random access procedure towards the SpCell.
In some embodiments,
   The UE includes the UE initiated (or event triggered) beam report indication in a UL grant for a Msg3/MsgA during the random access procedure. The Beam report indication can be in an RRC message or a MAC CE or a MAC subheader or a MAC subPDU included in the UL grant. The Beam report indication can be implicit based on a LCID/eLCID reserved for indicating the beam report indication wherein this LCID/eLCID is included in the MAC subheader of a MAC CE or a MAC subPDU in the Msg3/MsgA. For example, the MAC CE can be a C-RNTI MAC CE including this LCID/eLCID reserved for indicating the beam report indication in the MAC subheader. In another example, The MAC CE can be a new MAC CE including this LCID/eLCID reserved for indicating the beam report indication in the MAC subheader.
   The UE receives a UL grant after transmitting the Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the PDCCH is received after completion of the RA procedure.
Alternatively, in some embodiments,
   The UE indicates the UE initiated (or event triggered) beam report indication via a random access preamble by selecting the RO/preamble from ROs/preambles reserved for the UE initiated (or event triggered) beam report indication during the random access procedure. The ROs/preambles reserved for the UE initiated (or event triggered) beam report indication can be received by the UE from the base station in SI or an RRC message.
   The UE then transmits the UE initiated (or event triggered) beam report in the Msg3 or MsgA.

Alternatively, in some embodiments, at operation 1160, if the UE has valid CG PUSCH resources for transmitting the beam report for mode B based UE initiated (or event triggered) beam reporting and if the UE does not have valid PUCCH resource for transmitting UCI for mode B based UE initiated (or event triggered) beam reporting:
The UE does not transmit UCI on the PUCCH resources configured for Mode B based UE initiated (or event triggered) beam reporting to Cell B.
The UE transmits the UE initiated (or event triggered) beam report in the CG PUSCH to the serving cell (e.g., Cell A).

Alternatively, in some embodiments, at operation 1160, if the UE has valid CG PUSCH resources for transmitting the beam report for mode B based UE initiated (or event triggered) beam reporting and if the UE has valid PUCCH resource for transmitting UCI for mode B based UE initiated (or event triggered) beam reporting:
The UE transmits UCI on the PUCCH resources configured for Mode B based UE initiated (or event triggered) beam reporting to Cell B.
The UE then transmits UE initiated (or event triggered) beam report in the CG PUSCH to the serving cell (e.g., Cell A)

Alternatively, in some embodiments, at operation 1170, if the UE does not have valid CG PUSCH resources for transmitting the beam report for mode B based UE initiated (or event triggered) beam reporting:
The UE initiates a random access procedure towards the SpCell.
   In some embodiments, the UE transmits the UE initiated (or event triggered) beam report in an UL grant for a Msg3/MsgA during the random access procedure.
   Alternatively, in some embodiments, the UE receives an UL grant after transmitting a Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the PDCCH is received after completion of the RA procedure.

Alternatively, in some embodiments, at operation 1170, if the UE does not have valid CG PUSCH resources for transmitting the beam report for mode B based UE initiated (or event triggered) beam reporting:
The UE initiates a random access procedure towards SpCell.
In some embodiments,
   The UE includes a UE initiated (or event triggered) beam report indication in an UL grant for Msg3/MsgA during the random access procedure. The beam report indication can be in an RRC message or MAC CE or MAC subheader or MAC subPDU included in the UL grant. The beam report indication can be implicit based on an LCID/eLCID reserved for indicating the beam report indication wherein this LCID/eLCID is included in the MAC subheader of a MAC CE or a MAC subPDU in a Msg3/MsgA. For example, the MAC CE can be a C-RNTI MAC CE including this LCID/eLCID reserved for indicating the beam report indication in the MAC subheader. In another example, the MAC CE can be a new MAC CE including this LCID/eLCID reserved for indicating the beam report indication in the MAC subheader.
   The UE receives an UL grant after transmitting the Msg3/MsgA and the UE transmits UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to a C-RNTI wherein the PDCCH is received after completion of the RA procedure.
Alternatively, in some embodiments,
   The UE indicates UE initiated (or event triggered) beam report indication via a random access preamble by selecting the RO/preamble from ROs/preambles reserved for the UE initiated (or event triggered) beam report indication during the random access procedure. The ROs/preambles reserved for the UE initiated (or event triggered) beam report indication can be received by the UE from the base station in an SI or RRC message.
   The UE then transmits the UE initiated (or event triggered) beam reports in a Msg3 or MsgA.

Although FIG. 11 illustrates one example procedure for UE triggered beam reporting 1100, various changes may be made to FIG. 11. For example, while shown as a series of operations, various operations in FIG. 11 could overlap, occur in parallel, occur in a different order, occur any number of times, be omitted, or replaced by other operations.

In some embodiments, a UE initiated beam reporting is triggered. If UE is UL synchronized for a serving cell to which it may need to transmit UCI on a PUCCH for beam reporting or it may need to transmit a beam report on a CG PUSCH
A Mode is selected for UE initiated beam reporting
If the Selected Mode is A
   The UE transmits UCI on a PUCCH
   The UE receives a UL grant
   The UE transmits the report in the UL grant
If the Selected Mode is B
   The UE transmits UCI on a PUCCH
   The UE transmits the report in the CG grant for UE initiated beam reporting

### Otherwise,

The UE initiates a random access procedure towards the SpCell.
In some embodiments,
   The UE includes a UE initiated (or event triggered) beam report indication in an UL grant for a Msg3/MsgA during the random access procedure. The beam report indication can be in an RRC message or MAC CE or MAC subheader or MAC subPDU included in the UL grant. The beam report indication can be implicit based on an LCID/eLCID reserved for indicating a Beam report indication wherein this LCID/eLCID is included in the MAC subheader of a MAC CE or a MAC subPDU in a Msg3/MsgA. For example, the MAC CE can be a C-RNTI MAC CE including this LCID/eLCID reserved for indicating the beam report indication in the MAC subheader. In another example, the MAC CE can be a new MAC CE including this LCID/eLCID reserved for indicating the beam report indication in the MAC subheader.
   A UE receives an UL grant after transmitting the Msg3/MsgA and the UE transmits the UE initiated (or event triggered) beam report in this UL grant.
      This grant can be one which is scheduled by a PDCCH addressed to a C-RNTI based on which the random access procedure is considered completed. OR
      This grant can be one which is scheduled by a PDCCH addressed to C-RNTI wherein the PDCCH is received after completion of the RA procedure.
Alternatively, in some the UE indicates a UE initiated (or event triggered) beam report indication via a random access preamble by selecting an RO/preamble from ROs/preambles reserved for a UE initiated (or event triggered) beam report indication during the random access procedure. The ROs/preambles reserved for the UE initiated (or event triggered) beam report indication can be received by the UE from a base station in SI or an RRC message. The UE then transmits the UE initiated (or event triggered) beam report in a Msg3 or MsgA.

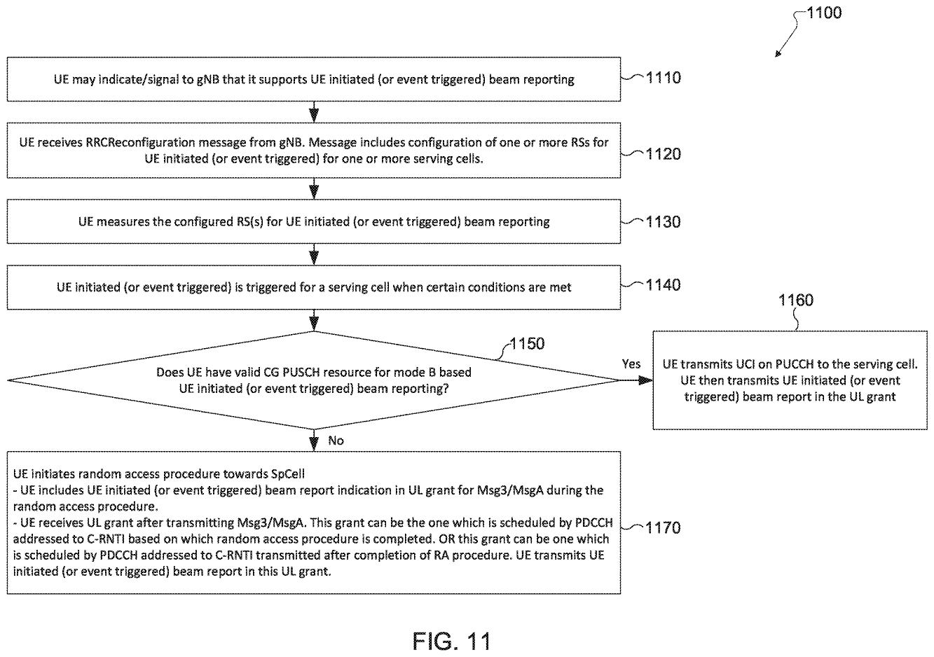

FIG. 12 illustrates an example method for UE indication of PUSCH repetition support 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for UE indication of PUSCH repetition support could be used without departing from the scope of this disclosure.

In the example of FIG. 12, the method 1200 begins at step 1210. At step 1210, a UE (such as UE 116 of FIG. 1) generates a MAC PDU. The MAC PDU includes a CCCH message, and information indicating that the UE supports Msg5 PUSCH repetition.

At step 1220, the UE transmits (e.g., to a BS such as gNB 102 of FIG. 1) the MAC PDU.

In some embodiments, the UE may initiate a random access procedure. In embodiments such as these, the MAC PDU may be transmitted in a Msg3 or MsgA during the random access procedure.

In some embodiments, the information indicating that the UE supports Msg5 PUSCH repetition can be a UE capability MAC CE including a UE capability bitmap with a bit in the bitmap corresponding to Msg5 PUSCH repetition set to 1.

In some embodiments, the information indicating that the UE supports Msg5 PUSCH repetition can be a UE capability header including a UE capability bitmap with a bit in the bitmap corresponding to Msg5 PUSCH repetition set to 1.

In some embodiments, the information indicating that the UE supports Msg5 PUSCH repetition can be a one-bit indication in the CCCH message.

In some embodiments, the information indicating that the UE supports Msg5 PUSCH repetition can be an establishment or resume cause in the CCCH message.

In some embodiments, the CCCH message can be an RRCResumeRequest message or an RRCSetupRequest message.

In some embodiments, the information indicating that the UE supports Msg5 PUSCH repetition can be a logical channel identifier LCID or an eLCID. In embodiments such as these, the UE may select an LCID or an eLCID. The UE may select the LCID or the eLCID based on (i) whether a size of the CCCH message is 48 bits or 64 bits, (ii) whether the UE is an enhanced eRedCap, a reduced capability RedCap UE, or neither an eRedCap UE nor a Redcap UE, or (iii) whether the UE supports PUCCH repetition of Msg4 hybrid automatic repeat request HARQ-acknowledgement (ACK).

In some embodiments, to generate the MAC PDU to include the information indicating that the UE supports Msg5 PUSCH repetition, the UE may generate the MAC PDU to indicate the selected LCID or eLCID in a MAC subheader of the CCCH message.

In some embodiments, the UE may select the LCID or eLCID from a set of twelve LCIDs or eLCIDS reserved for indicating support of Msg5 PUSCH repetition.

In some embodiments, the UE may select a first LCID or eLCID from the set in response to (i) a size of the CCCH message being 48 bits, (ii) the UE being an eRedCap UE, (iii) the UE supporting Msg5 PUSCH repetition, and (iv) the UE supporting PUCCH repetition of Msg4 HARQ-ACK;

In some embodiments, the UE may select a second LCID or eLCID from the set in response to (i) a size of the CCCH message being 64 bits, (ii) the UE being an eRedCap UE, (iii) the UE supporting Msg5 PUSCH repetition, and (iv) the UE supporting PUCCH repetition of Msg4 HARQ-ACK;

In some embodiments, the UE may select a third LCID or eLCID from the set in response to (i) a size of the CCCH message being 48 bits, (ii) the UE being a RedCap UE, (iii) the UE supporting Msg5 PUSCH repetition, and (iv) the UE supporting PUCCH repetition of Msg4 HARQ-ACK;

In some embodiments, the UE may select a fourth LCID or eLCID from the set in response to (i) a size of the CCCH message being 64 bits, (ii) the UE being a RedCap UE, (iii) the UE supporting Msg5 PUSCH repetition, and (iv) the UE supporting PUCCH repetition of Msg4 HARQ-ACK;

In some embodiments, the UE may select a fifth LCID or eLCID from the set in response to (i) a size of the CCCH message being 48 bits, (ii) the UE being neither a RedCap nor an eRedCap UE, (iii) the UE supporting Msg5 PUSCH repetition, and (iv) the UE supporting PUCCH repetition of Msg4 HARQ-ACK;

In some embodiments, the UE may select a sixth LCID or eLCID from the set in response to (i) a size of the CCCH message being 64 bits, (ii) the UE being neither a RedCap nor an eRedCap UE, (iii) the UE supporting Msg5 PUSCH repetition, and (iv) the UE supporting PUCCH repetition of Msg4 HARQ-ACK;

In some embodiments, the UE may select a seventh LCID or eLCID from the set in response to (i) a size of the CCCH message being 48 bits, (ii) the UE being an eRedCap UE, and (iii) the UE supporting Msg5 PUSCH repetition;

In some embodiments, the UE may select an eighth LCID or eLCID from the set in response to (i) a size of the CCCH message being 64 bits, (ii) the UE being an eRedCap UE, and (iii) the UE supporting Msg5 PUSCH repetition;

In some embodiments, the UE may select a nineth LCID or eLCID from the set in response to (i) a size of the CCCH message being 48 bits, (ii) the UE being a RedCap UE, and (iii) the UE supporting Msg5 PUSCH repetition;

In some embodiments, the UE may select a tenth LCID or eLCID from the set in response to (i) a size of the CCCH message being 64 bits, (ii) the UE being a RedCap UE, and (iii) the UE supporting Msg5 PUSCH repetition;

In some embodiments, the UE may select an eleventh LCID or eLCID from the set in response to (i) a size of the CCCH message being 48 bits, (ii) the UE being neither a RedCap nor an eRedCap UE, and (iii) the UE supporting Msg5 PUSCH repetition.

In some embodiments, the UE may select LCID or eLCID from the set in response to (i) a size of the CCCH message being 64 bits, (ii) the UE being neither a RedCap nor an eRedCap UE, and (iii) the UE supporting Msg5 PUSCH repetition.

Although FIG. 12 illustrates one example method for UE indication of PUSCH repetition support 1200, various changes may be made to FIG. 12. For example, while shown as a series of steps, various steps in FIG. 12 could overlap, occur in parallel, occur in a different order, occur any number of times, be omitted, or replaced by other steps.

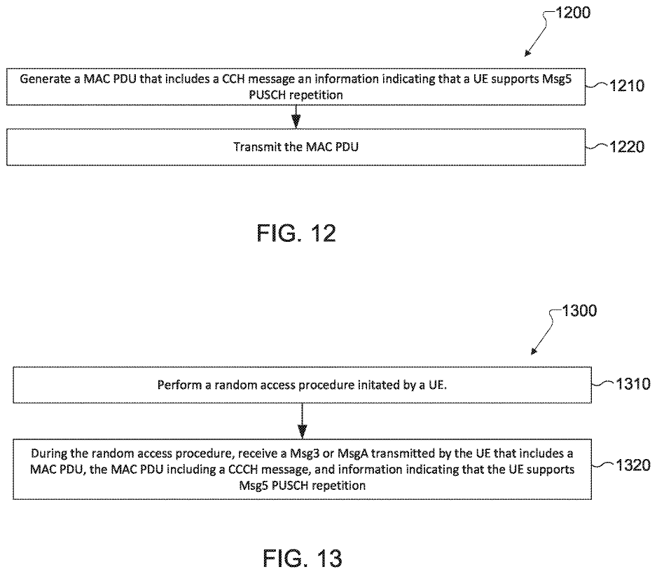

FIG. 13 illustrates another example method for UE indication of PUSCH repetition support 1300 according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for UE indication of PUSCH repetition support could be used without departing from the scope of this disclosure.

In the example of FIG. 13, the method 1300 begins at step 1310. At step 1310, a BS (such as gNB 102 of FIG. 1) performs a random access procedure initiated by a UE (such as UE 116 of FIG. 1).

At step 1320, during the random access procedure, the BS receives a Msg3 or MsgA transmitted by the UE. The Msg3 or MsgA includes a MAC PDU. The MAC PDU includes a CCCH message, and information indicating that the UE supports Msg5 PUSCH repetition.

In some embodiments, the information indicating that the UE supports Msg5 PUSCH repetition can be a UE capability MAC CE including a UE capability bitmap with a bit in the bitmap corresponding to Msg5 PUSCH repetition set to 1.

In some embodiments, the information indicating that the UE supports Msg5 PUSCH repetition can be a UE capability header including a UE capability bitmap with a bit in the bitmap corresponding to Msg5 PUSCH repetition set to 1.

In some embodiments, the information indicating that the UE supports Msg5 PUSCH repetition can be a one-bit indication in the CCCH message.

In some embodiments, the information indicating that the UE supports Msg5 PUSCH repetition can be an establishment or resume cause in the CCCH message.

In some embodiments, the CCCH message can be an RRCResumeRequest message or an RRCSetupRequest message.

In some embodiments, the information indicating that the UE supports Msg5 PUSCH repetition can be a logical channel identifier LCID or an eLCID. In embodiments such as these, the UE may select an LCID or an eLCID. The UE may select the LCID or the eLCID based on (i) whether a size of the CCCH message is 48 bits or 64 bits, (ii) whether the UE is an enhanced eRedCap, a reduced capability RedCap UE, or neither an eRedCap UE nor a Redcap UE, or (iii) whether the UE supports PUCCH repetition of Msg4 hybrid automatic repeat request HARQ-acknowledgement (ACK).

In some embodiments, to generate the MAC PDU to include the information indicating that the UE supports Msg5 PUSCH repetition, the UE may generate the MAC PDU to indicate the selected LCID or eLCID in a MAC subheader of the CCCH message.

Although FIG. 13 illustrates one example method for UE indication of PUSCH repetition support 1300, various changes may be made to FIG. 13. For example, while shown as a series of steps, various steps in FIG. 13 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
generating a medium access control (MAC) protocol data unit (PDU) that includes:
a common control channel (CCCH) message; and
information indicating that the UE supports message 5 (Msg5) physical uplink shared channel (PUSCH) repetition; and
transmitting the MAC PDU.

2. The method of claim 1, further comprising initiating a random access procedure, wherein the MAC PDU is transmitted in a message 3 (Msg3) or message A (MsgA) during the random access procedure.

3. The method of claim 1, wherein the information indicating that the UE supports Msg5 PUSCH repetition is a UE capability MAC configuration element (CE) including a UE capability bitmap with a bit in the bitmap corresponding to Msg5 PUSCH repetition set to 1.

4. The method of claim 1, wherein the information indicating that the UE supports Msg5 PUSCH repetition is a UE capability header including a UE capability bitmap with a bit in the bitmap corresponding to Msg5 PUSCH repetition set to 1.

5. The method of claim 1, wherein the information indicating that the UE supports Msg5 PUSCH repetition is a one-bit indication in the CCCH message.

6. The method of claim 1, wherein the information indicating that the UE supports Msg5 PUSCH repetition is an establishment or resume cause in the CCCH message.

7. The method of claim 1, wherein the CCCH message is an RRCResumeRequest message or an RRCSetupRequest message.

8. The method of claim 1, wherein:
the information indicating that the UE supports Msg5 PUSCH repetition is a logical channel identifier (LCID) or an extended LCID (eLCID); and
the method further comprises selecting an LCID or eLCID based on at least one of:
whether a size of the CCCH message is 48 bits or 64 bits;
whether the UE is an enhanced reduced capability (eRedCap), a reduced capability (RedCap) UE, or neither an eRedCap UE nor a Redcap UE; or
whether the UE supports PUCCH repetition of message 4 (Msg4) hybrid automatic repeat request (HARQ)-acknowledgement (ACK).

9. The method of claim 8, wherein generating the MAC PDU to include the information indicating that the UE supports Msg5 PUSCH repetition comprises generating the MAC PDU to indicate the selected LCID or eLCID in a MAC subheader of the CCCH message.

10. The method of claim 8, wherein:
the UE selects the LCID or eLCID from a set of twelve LCIDs or eLCIDs reserved for indicating support of Msg5 PUSCH repetition;
the UE selects a first LCID or eLCID from the set in response to (i) a size of the CCCH message being 48 bits, (ii) the UE being an eRedCap UE, (iii) the UE supporting Msg5 PUSCH repetition, and (iv) the UE supporting PUCCH repetition of Msg4 HARQ-ACK;
the UE selects a second LCID or eLCID from the set in response to (i) a size of the CCCH message being 64 bits, (ii) the UE being an eRedCap UE, (iii) the UE supporting Msg5 PUSCH repetition, and (iv) the UE supporting PUCCH repetition of Msg4 HARQ-ACK;
the UE selects a third LCID or eLCID from the set in response to (i) a size of the CCCH message being 48 bits, (ii) the UE being a RedCap UE, (iii) the UE supporting Msg5 PUSCH repetition, and (iv) the UE supporting PUCCH repetition of Msg4 HARQ-ACK;
the UE selects a fourth LCID or eLCID from the set in response to (i) a size of the CCCH message being 64 bits, (ii) the UE being a RedCap UE, (iii) the UE supporting Msg5 PUSCH repetition, and (iv) the UE supporting PUCCH repetition of Msg4 HARQ-ACK;
the UE selects a fifth LCID or eLCID from the set in response to (i) a size of the CCCH message being 48 bits, (ii) the UE being neither a RedCap nor an eRedCap UE, (iii) the UE supporting Msg5 PUSCH repetition, and (iv) the UE supporting PUCCH repetition of Msg4 HARQ-ACK;
the UE selects a sixth LCID or eLCID from the set in response to (i) a size of the CCCH message being 64 bits, (ii) the UE being neither a RedCap nor an eRedCap UE, (iii) the UE supporting Msg5 PUSCH repetition, and (iv) the UE supporting PUCCH repetition of Msg4 HARQ-ACK;
the UE selects a seventh LCID or eLCID from the set in response to (i) a size of the CCCH message being 48 bits, (ii) the UE being an eRedCap UE, and (iii) the UE supporting Msg5 PUSCH repetition;
the UE selects an eighth LCID or eLCID from the set in response to (i) a size of the CCCH message being 64 bits, (ii) the UE being an eRedCap UE, and (iii) the UE supporting Msg5 PUSCH repetition;
the UE selects a nineth LCID or eLCID from the set in response to (i) a size of the CCCH message being 48 bits, (ii) the UE being a RedCap UE, and (iii) the UE supporting Msg5 PUSCH repetition;
the UE selects a tenth LCID or eLCID from the set in response to (i) a size of the CCCH message being 64 bits, (ii) the UE being a RedCap UE, and (iii) the UE supporting Msg5 PUSCH repetition;
the UE selects an eleventh LCID or eLCID from the set in response to (i) a size of the CCCH message being 48 bits, (ii) the UE being neither a RedCap nor an eRedCap UE, and (iii) the UE supporting Msg5 PUSCH repetition; and
the UE selects a twelfth LCID or eLCID from the set in response to (i) a size of the CCCH message being 64 bits, (ii) the UE being neither a RedCap nor an eRedCap UE, and (iii) the UE supporting Msg5 PUSCH repetition.

11. A method of operating a base station (BS), the method comprising:
receiving a medium access control (MAC) protocol data unit (PDU) generated by a UE,
wherein the MAC PDU includes:
a common control channel (CCCH) message; and
information indicating that the UE supports message 5 (Msg5) physical uplink shared channel (PUSCH) repetition.

12. The method of claim 11, further comprising performing a random access procedure initiated by the UE,
wherein MAC PDU is received in a message 3 (Msg3) or message A (MsgA) during the random access procedure.

13. The method of claim 11, wherein the information indicating that the UE supports Msg5 PUSCH repetition is a UE capability MAC configuration element (CE) including a UE capability bitmap with a bit in the bitmap corresponding to Msg5 PUSCH repetition set to 1.

14. The method of claim 11, wherein the information indicating that the UE supports Msg5 PUSCH repetition is a UE capability header including a UE capability bitmap with a bit in the bitmap corresponding to Msg5 PUSCH repetition set to 1.

15. The method of claim 11, wherein the information indicating that the UE supports Msg5 PUSCH repetition is a one-bit indication in the CCCH message.

16. The method of claim 11, wherein the information indicating that the UE supports Msg5 PUSCH repetition is an establishment or resume cause in the CCCH message.

17. The method of claim 11, wherein the CCCH message is an RRCResumeRequest message or and RRCSetupRequest message.

18. The method of claim 11, wherein:
the information indicating that the UE supports Msg5 PUSCH repetition is a logical channel identifier (LCID) or an extended LCID (eLCID),
wherein an LCID or eLCID is selected by the UE based on at least one of:
whether a size of the CCCH message is 48 bits or 64 bits;
whether the UE is an enhanced reduced capability (eRedCap), a reduced capability (RedCap) UE, or neither an eRedCap UE nor a Redcap UE; or
whether the UE supports PUCCH repetition of message 4 (Msg4) hybrid automatic repeat request (HARQ)-acknowledgement (ACK).

19. The method of claim 18, wherein the MAC PDU indicates the selected LCID or eLCID selected by the UE in a MAC subheader of the CCCH message.

20. An electronic device comprising:
at least on processor including processing circuitry; and
memory storing instructions, wherein the instructions, when executed by the at least one processor individually or collectively, cause the electronic device to:
generate a medium access control (MAC) protocol data unit (PDU) that includes:
a common control channel (CCCH) message; and
information indicating that the electronic device supports message 5 (Msg5) physical uplink shared channel (PUSCH) repetition; and
transmit the MAC PDU.
